(19) United States
(12) Patent Application Publication
(10) Pub. No.: US 2012/0120888 A1
(43) Pub. Date: May 17, 2012

(54) APPARATUS AND METHOD FOR PRIMARY UPLINK SHARED CHANNEL HOPPING IN A WIRELESS NETWORK

(75) Inventors: Guowang Miao, Plano, TX (US); Young-Han Nam, Richardson, TX (US); Jianzhong Zhang, Plano, TX (US)

(73) Assignee: Samsung Electronics Co., Ltd., Suwon-si (KR)

(21) Appl. No.: 13/286,750

(22) Filed: Nov. 1, 2011

Related U.S. Application Data
(60) Provisional application No. 61/409,446, filed on Nov. 2, 2010.
(60) Provisional application No. 61/411,821, filed on Nov. 9, 2010.

(51) Int. Cl. H04W 72/04

(52) U.S. Cl. 370/329

(57) ABSTRACT

A wireless communication system includes a base station capable of communicating with a plurality of subscriber stations includes a controller configured to perform a frequency hop within a selected subset of a physical uplink shared channel (PUSCH). The PUSCH includes a plurality of available resource blocks and a plurality of restricted resource blocks. The base station includes a transmit path comprising circuitry configured to transmit control information and data to at least one of the plurality of subscriber stations in a sub-frame. The transmit path is also configured to transmit a plurality of resource blocks in the sub-frame. Further, the transmit path maps a plurality virtual resource blocks (VRB) to a plurality of available physical resource blocks (PRB) within a limited bandwidth of the sub-frame. The sub-frame includes the limited bandwidth and a plurality of restricted resource blocks.

### CROSS-REFERENCE TO RELATED APPLICATION(S) AND CLAIM OF PRIORITY

The present application is related to U.S. Provisional Patent Application No. 61/409,446, filed Nov. 2, 2010, entitled “PUSCH HOPPING IN WIRELESS NETWORKS”, and U.S. Provisional Patent Application No. 61/411,821, filed Nov. 9, 2010, entitled “VRB DESIGN FOR WIRELESS COMMUNICATIONS”. Provisional Patent Application No. 61/409,446 and 61/411,821 are assigned to the assignee of the present application and is hereby incorporated by reference into the present application as if fully set forth herein. The present application hereby claims priority under 35 U.S.C. §119(e) to U.S. Provisional Patent Application No. 61/409,446 and 61/411,821.

### TECHNICAL FIELD OF THE INVENTION

The present application relates generally to wireless communications and, more specifically, to an apparatus and method for physical uplink shared channel hopping in a wireless communication network.

### BACKGROUND OF THE INVENTION

Modern communications demand higher data rates and performance. Multiple-input multiple-output (MIMO) antenna systems, also known as multiple-element antenna (MEA) systems, achieve greater spectral efficiency for allocated radio frequency (RF) channel bandwidths by utilizing space or antenna diversity at both the transmitter and the receiver, or in other cases, the transceiver.

In MIMO systems, each of a plurality of data streams is individually mapped and modulated before being precoded and transmitted by different physical antennas or effective antennas. The combined data streams are then received at multiple antennas of a receiver. At the receiver, each data stream is separated and extracted from the combined signal. This process is generally performed using a minimum mean squared error (MMSE) or MMSE-successive interference cancellation (SIC) algorithm.

Additionally, a downlink physical signal corresponds to a set of resource elements used by the physical layer but does not carry information originating from higher layers. The following downlink physical signals are defined: Synchronization signal and Reference signal.

The reference signal consists of known symbols transmitted at a well defined OFDM symbol position in the slot. This assists the receiver at the user terminal in estimating the channel impulse response to compensate for channel distortion in the received signal. There is one reference signal transmitted per downlink antenna port and an exclusive symbol position is assigned for an antenna port (when one antenna port transmits a reference signal other ports are silent). Reference signals (RS) are used to determine the impulse response of the underlying physical channels.

### SUMMARY OF THE INVENTION

A subscriber station capable of communicating with a plurality of base stations in a wireless communication network is provided. The subscriber station includes an antenna configured to receive data from and transmit data to at least one of a plurality of base stations. The subscriber station also includes a controller configured to perform a frequency hop within a selected subset of a physical uplink shared channel (PUSCH). The PUSCH includes a plurality of available resource blocks and a plurality of restricted resource blocks. In addition, the controller is configured to select a resource allocation within the plurality of available resource blocks.

A base station capable of communicating with a plurality of subscriber stations is provided. The base station includes a transmit path comprising circuitry configured to transmit control information and data to at least one of the plurality of subscriber stations in a sub-frame. The transmit path is also configured to transmit a plurality of resource blocks in the sub-frame. Further, the transmit path maps a plurality virtual resource blocks (VRB) to a plurality of available physical resource blocks (PRB) within a limited bandwidth of the sub-frame. The sub-frame includes the limited bandwidth and a plurality of restricted resource blocks.

A method for resource allocation is provided. The method includes transmitting control information and data to at least one of a plurality of subscriber stations in a sub-frame. In addition, the method includes mapping a plurality virtual resource blocks (VRB) to a plurality of available physical resource blocks (PRB) within a limited bandwidth of the sub-frame, wherein the sub-frame comprises the limited bandwidth and a plurality of restricted resource blocks. Further, the method includes transmitting the plurality of available PRB in the sub-frame.

A method for physical uplink shared channel hopping is provided. The method includes receiving control information and data from at least one of a plurality of base stations in a sub-frame. In addition, the method includes performing a frequency hop within a selected subset of a physical uplink shared channel (PUSCH). The PUSCH includes a plurality of available resource blocks and a plurality of restricted resource blocks. In addition, the method includes selecting a resource allocation within the plurality of available resource blocks.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network, which transmits resource blocks according to embodiments of the present disclosure;

FIG. 2A illustrates a high-level diagram of an orthogonal frequency division multiple access transmit path according to embodiments of the present disclosure;

FIG. 2B illustrates a high-level diagram of a single carrier frequency division multiple access receive path according to embodiments of the present disclosure;

FIG. 3 illustrates an exemplary wireless subscriber station according to embodiments of the present disclosure;

FIG. 4 illustrates Inter-cell Interference Coordination according to the disclosure;

FIG. 5 illustrates a heterogeneous network according to the disclosure;

FIGS. 6A and 6B illustrate subsets of resource blocks used for physical uplink shared channel hopping according to embodiments of the present disclosure;

FIG. 7 illustrates example resource assignments for slots according to embodiments of the present disclosure;

FIG. 8 illustrates resource assignments for slots issued in the scheduling grant according to embodiments of the present disclosure;

FIG. 9 illustrates a hopping start position and number of sub-bands signaled to the subscriber station via higher layer signaling according to embodiments of the present disclosure;

FIGS. 10A and 10B illustrate a Type-2 hopping function on the sub-bands within the subset of available RBs according to embodiments of the present disclosure;

FIG. 11 illustrates a Type-2 hopping function on the sub-bands within the subset of available non-contiguous RBs according to embodiments of the present disclosure;

FIG. 12 illustrates a hopping in which the overall PUSCH bandwidth into a number of equal contiguous sub-bands according to embodiments of the present disclosure;

FIGS. 13A through 13D illustrate a Type-2 hopping function on the sub-bands within the subset of available non-contiguous RBs according to embodiments of the present disclosure

FIGS. 14 and 15 illustrate a limited bandwidth for downlink communications according to embodiments of the present disclosure; and

FIGS. 16 through 22 illustrate VRB mapping functions according to embodiments of the present disclosure.

### DETAILED DESCRIPTION OF THE INVENTION

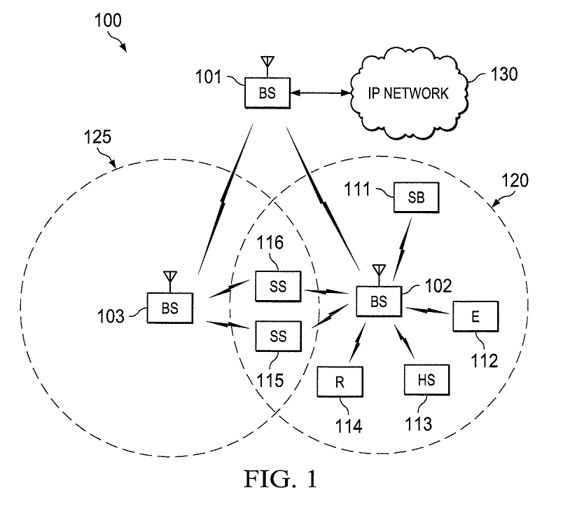

FIGS. 1 through 22, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication network.

It will be understood that although examples herein may refer to a specific communication standard, such as by terms aligned with an IEEE 802.16m (802.16) or Long Term Evolution (LTE) system, embodiments of the present disclosure are not limited in LTE system, and can be used in any communication system and network, with the terms referred to by different names. The following are some examples. User Equipment (UE), Mobile station (MS) or Advanced mobile station (AMS) are meant to refer the subscriber station (SS). Enhanced-Node-B (e-NodeB, e-NB, or Node-B), Base station (BS), Advanced base station (ABS), and Femto base station (FBS) are meant to refer the base station. A picocell is a small base station that typically covers a small area, such as in-building (offices, shopping malls, train stations, stock exchanges, and the like), or vehicles. Cell ID or Preamble refers the physical level identifier of the base station, usually conveyed in synchronization channel. The cell ID could be reused within a type of base station. Frequency allocation (FA), or carrier frequency, refers the frequency carrier (spectrum) used by a base station. Handover (HO) refers that an MS is handed over to a serving BS to a targeting BS. Handover command (HO-CMD) refers a message used to notify MS how/when to handover. Base station identifier (BSID) refers a globally unique identifier of the base station. Super frame header (SFH) is part of the broadcast channel (BCH). SFH contains most important system information. Advanced air interface (AAI) may be used as the prefix of some control messages, and they are interchangeable to those messages without such prefix.

The uplink allocations in Single Carrier Frequency-Division Multiple Access scheme (SC-FDMA) are contiguous to maintain the single-carrier property. Distributed resource allocation is not used in the uplink transmission to recuperate frequency diversity. However, frequency hopping can be used to provide frequency diversity while keeping the resource allocations contiguous. The LTE systems allows the configuration of either inter-subframe hopping or both inter-subframes and intra-subframe hopping. In the case of intra-subframe hopping, resources are hopped across the two slots within a subframe. It should be noted that hopping at SC-FDMA symbol level is not permitted since there is a single reference signal symbol per slot. Moreover, a no hopping transmissions mode is supported to enable uplink frequency-selective scheduling where diversity can degrade performance.

FIG. 1 illustrates an exemplary wireless network, which transmits resource blocks according to an exemplary embodiment of the disclosure. The embodiment of the wireless network 100 shown in FIG. 1 is for illustration only. Other embodiments could be used without departing from the scope of this disclosure.

In the example illustrated in FIG. 1, wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of subscriber stations within coverage area 120 of base station 102. The first plurality of subscriber stations includes subscriber station 111, which may be located in a small business (SB), subscriber station 112, which may be located in an enterprise (E), subscriber station 113, which may be located in a wireless fidelity (WiFi) hotspot (HS), subscriber station 114, which may be located in a first residence (R), subscriber station 115, which may be located in a second residence (R), and subscriber station 116, which may be a mobile device (M), such as a cell phone, a wireless laptop, a wireless PDA, or the like.

Base station 103 provides wireless broadband access (via base station 101) to Internet 130 to a second plurality of subscriber stations within coverage area 125 of base station 103. The second plurality of subscriber stations includes subscriber station 115 and subscriber station 116. In an exemplary embodiment, base stations 101-103 may communicate with each other and with subscriber stations 111-116 using OFDM or OFDMA techniques.

Base station 101 may be in communication with either a greater number or a lesser number of base stations. Furthermore, while only six subscriber stations are depicted in FIG. 1, it is understood that wireless network 100 may provide wireless broadband access to additional subscriber stations. It is noted that subscriber station 115 and subscriber station 116 are located on the edges of both coverage area 120 and coverage area 125. Subscriber station 115 and subscriber station 116 each communicate with both base station 102 and base station 103 and may be said to be operating in handoff mode, as known to those of skill in the art.

Subscriber stations 111-116 may access voice, data, video, video conferencing, and/or other broadband services via Internet 130. In an exemplary embodiment, one or more of subscriber stations 111-116 may be associated with an access point (AP) of a WiFi WLAN. Subscriber station 116 may be any of a number of mobile devices, including a wireless-enabled laptop computer, personal data assistant, notebook, handheld device, or other wireless-enabled device. Subscriber stations 114 and 115 may be, for example, a wireless-enabled personal computer (PC), a laptop computer, a gateway, or another device.

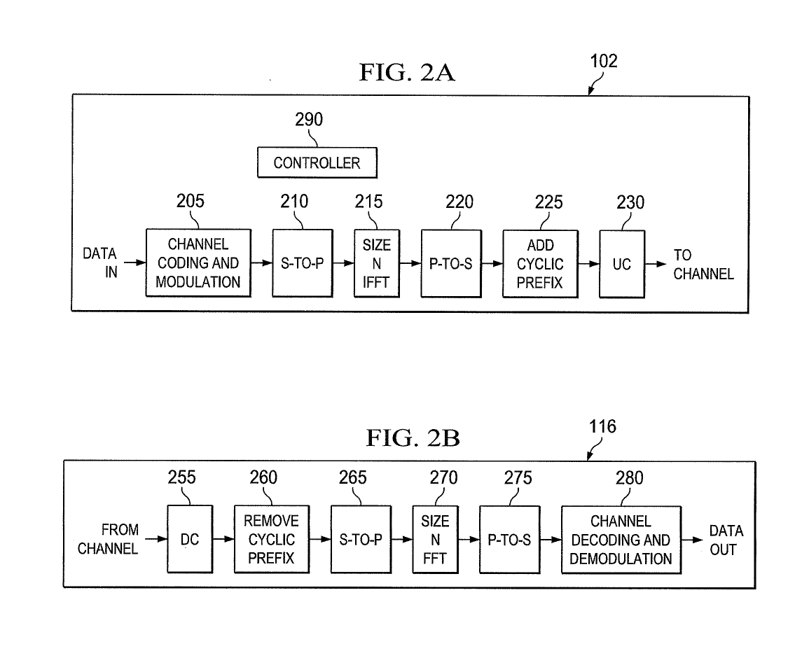

FIG. 2A is a high-level diagram of an orthogonal frequency division multiple access (OFDMA) transmit path. FIG. 2B is a high-level diagram of a single-carrier frequency division multiple access (SC-FDMA) receive path. In FIGS. 2A and 2B, the OFDMA transmit path is implemented in base station (BS) 102 and the SC-FDMA receive path is implemented in subscriber station (SS) 116 for the purposes of illustration and explanation only. However, it will be understood by those skilled in the art that an OFDMA receive path may also be implemented in BS 102 and an SC-FDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230, and a controller 290 configured to allocate resource blocks and assign hopping schemes for use by one or more subscriber stations. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

In BS 102, channel coding and modulation block 205 receives a set of information bits, applies coding (e.g., LDPC coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The base station 102 can enable (e.g., activate) all of its antenna ports or a subset of antenna ports. For example, when BS 102 includes eight antenna ports, BS 102 can enable four of the antenna ports for use in transmitting information to the subscriber stations. It will be understood that illustration of BS 102 enabling four antenna ports is for example purposes only and that any number of antenna ports could be activated.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to subscriber stations 111-116 and may implement a receive path that is analogous to receiving in the uplink from subscriber stations 111-116. Similarly, each one of subscriber stations 111-116 may implement a transmit path corresponding to the architecture for transmitting in the uplink to base stations 101-103 and may implement a receive path corresponding to the architecture for receiving in the downlink from base stations 101-103.

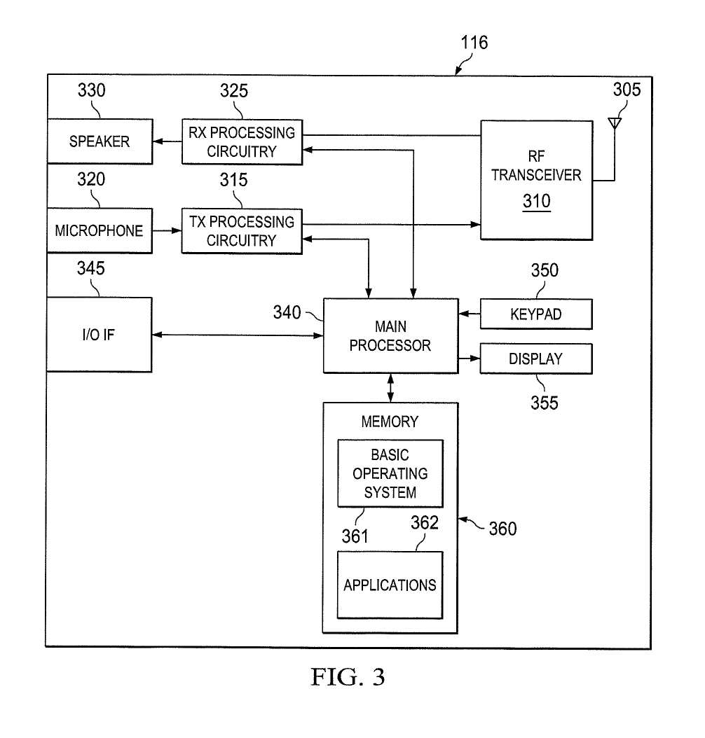

FIG. 3 illustrates an exemplary wireless subscriber station according to embodiments of the present disclosure. The embodiment of wireless subscriber station 116 illustrated in FIG. 3 is for illustration only. Other embodiments of the wireless subscriber station 116 could be used without departing from the scope of this disclosure.

Wireless subscriber station 116 comprises antenna 305, radio frequency (RF) transceiver 310, transmit (TX) processing circuitry 315, microphone 320, and receive (RX) processing circuitry 325. SS 116 also comprises speaker 330, main processor 340, input/output (I/O) interface (IF) 345, keypad 350, display 355, and memory 360. Memory 360 further comprises basic operating system (OS) program 361 and a plurality of applications 362. The plurality of applications can include one or more of resource mapping tables (Tables 1-10 described in further detail herein below).

Radio frequency (RF) transceiver 310 receives from antenna 305 an incoming RF signal transmitted by a base station of wireless network 100. Radio frequency (RF) transceiver 310 down-converts the incoming RF signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In some embodiments of the present disclosure, main processor 340 is a microprocessor or microcontroller. Memory 360 is coupled to main processor 340. According to some embodiments of the present disclosure, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless subscriber station 116. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360, such as operations for Physical Uplink Shared Channel (PUSCH) hopping and mapping virtual resource blocks (VRB) into limited bandwidths (BW). Main processor 340 can move data into or out of memory 360, as required by an executing process. In some embodiments, the main processor 340 is configured to execute a plurality of applications 362, such as applications for (PUSCH) hopping and mapping VRB into limited BW. The main processor 340 can operate the plurality of applications 362 based on OS program 361 or in response to a signal received from BS 102. Main processor 340 is also coupled to I/O interface 345. I/O interface 345 provides subscriber station 116 with the ability to connect to other devices such as laptop computers and handheld computers. I/O interface 345 is the communication path between these accessories and main controller 340.

Main processor 340 is also coupled to keypad 350 and display unit 355. The operator of subscriber station 116 uses keypad 350 to enter data into subscriber station 116. Display 355 may be a liquid crystal display capable of rendering text and/or at least limited graphics from web sites. Alternate embodiments may use other types of displays.

A UE, such as SS 116, performs Physical Uplink Shared Channel (PUSCH) frequency hopping if the single bit frequency hopping (FH) field in a corresponding Physical Downlink Control Channel (PDCCH) with Downlink Control Information (DCI) format 0 is set to 1 otherwise no PUSCH frequency hopping is performed.

When SS 116 performs PUSCH frequency hopping, SS 116 determines its PUSCH resource allocation (RA) for the first slot of a subframe (S1) including the lowest index PRB

$$( {n}_{PRB}^{S 1} ( n ) )$$

in subframe n from the resource allocation field in the latest PDCCH with DCI format 0 for the same transport block. If there is no PDCCH for the same transport block, SS 116 determines its hopping type based on:

1) the hopping information in the most recent semi-persistent scheduling assignment PDCCH, when the initial PUSCH for the same transport block is semi-persistently scheduled; or

2) the random access response grant for the same transport block, when the PUSCH is initiated by the random access response grant.

The resource allocation field in DCI format 0 excludes either 1 or 2 bits used for hopping information as indicated by Table 8.4-1 in 3GPP 36.213, “Universal Terrestrial Radio Access (E-UTRA); Physical layer procedures”, the contents of which are incorporated by reference in their entirety. Expressing the uplink system bandwidth

$${N}_{RB}^{UL}$$

in terms of number of resource blocks, the number of PUSCH resource blocks used for PUSCH hopping is as shown in Equation 1:

$${N}_{RB}^{PUSCH} = \{ \begin{matrix}{N}_{RB}^{UL} - {\tilde{N}}_{RB}^{HO} - ( {N}_{RB}^{UL} mod 2 ) & Type 1 PUSCH hopping \\ {N}_{RB}^{UL} & Type 2 {N}_{sb} = 1 PUSCH hopping \\ {N}_{RB}^{UL} - {\tilde{N}}_{RB}^{HO} & Type 2 {N}_{sb} > 1 PUSCH hopping\end{matrix} \qquad [ Eqn . 1 ]$$

For type 1 and type 2 PUSCH hopping,

$${\tilde{N}}_{RB}^{HO} = {N}_{RB}^{HO} + 1$$

if

$${N}_{RB}^{HO}$$

is an odd number where

$${N}_{RB}^{HO}$$

defined in 3GPP TS 36.211: “Evolved Universal Terrestrial Radio Access (E-UTRA); Physical channels and modulation”, the contents of which are incorporated by reference in their entirety. Additionally,

$${\tilde{N}}_{RB}^{HO} = {N}_{RB}^{HO}$$

in other cases. The size of the resource allocation field in DCI format 0 after excluding either 1 or 2 bits is shown in Equation 2: bits.

$$y = ⌈ {log}_{2} ( {N}_{R B}^{UL} ( {N}_{RB}^{UL} + 1 ) / 2 ) ⌉ - {N}_{UL \_ hop} , \\ where {N}_{UL \_ hop} = 1 or 2 \qquad [ Eqn . 2 ]$$

The number of contiguous resource blocks (RBs) that can be assigned to a type-1 hopping user is limited to

$$⌊ {2}^{y} / {N}_{RB}^{UL} ⌋ .$$

The number of contiguous RBs that can be assigned to a type-2 hopping user is limited to min

$$( ⌊ {2}^{y} / {N}_{RB}^{UL} ⌋ , ⌊ {N}_{RB}^{PUSCH} / {N}_{sb} ⌋ ) ,$$

where the number of sub-bands N_{sb} is given by higher layers.

When performing PUSCH frequency hopping, SS 116 uses one of two possible PUSCH frequency hopping types based on the hopping information. The parameter Hopping-mode provided by higher layers determines if PUSCH frequency hopping is “inter-subframe” or “intra and inter-subframe”.

For a first type of hopping, Type 1 PUSCH Hopping, the hopping information is provided in the scheduling grant. Thus, it can be referenced as “hopping based on explicit hopping information in the scheduling grant”. To maintain the single carrier property of the LTE uplink, users are allocated on contiguously allocated resource blocks, starting from the lowest index physical resource block (PRB) in each transmission slot.

The lowest index PRB

$$( {n}_{PRB}^{S 1} ( i ) )$$

of the 1^{st} slot RA in subframe i is defined as shown in Equation 3:

$${n}_{PRB}^{S 1} ( i ) = {\tilde{n}}_{PRB}^{S 1} ( i ) + \frac{{\tilde{N}}_{RB}^{HO}}{2} \qquad [ Eqn . 3 ]$$

In Equation 3,

$${n}_{PRB}^{S 1} ( i ) = R {B}_{START} ,$$

and RB_{START} is obtained from the uplink scheduling grant as in Section 8.4 and Section 8.1 of Universal Terrestrial Radio Access (E-UTRA); Physical layer procedures.

The lowest index PRB (n_{PRB}(i)) of the 2^{nd} slot RA in subframe i is defined as shown in Equation 4:

$${n}_{PRB} ( i ) = {\tilde{n}}_{PRB} ( i ) + \frac{{\tilde{N}}_{RB}^{HO}}{2} \qquad [ Eqn . 4 ]$$

For PUSCH hopping type 1, the hopping bit or bits indicated in Table 8.4-1 determine ñ_{PRB}(i) as defined in Table 8.4-2 of Universal Terrestrial Radio Access (E-UTRA); Physical layer procedures.

The set of physical resource blocks to be used for PUSCH transmission are L_{CRBs} contiguously allocated resource blocks from PRB index

$${n}_{PRB}^{S 1} ( i )$$

for the 1^{st} slot, and from PRB index n_{PRB}(i) for the 2^{nd} slot, respectively, where L_{CRBs} is obtained from the uplink scheduling grant as described below.

The resource allocation information indicates to a scheduled UE, such as SS 116, a set of contiguously allocated virtual resource block indices denoted by n_{VRB}. A resource allocation field in the scheduling grant consists of a resource indication value (RIV) corresponding to a starting resource block (RB_{START}) and a length in terms of contiguously allocated resource blocks (L_{CRBs}≧1). The resource indication value is defined by Equation set 5:

$$if ( {L}_{CRBs} - 1 ) \leq ⌊ {N}_{RB}^{UL} / 2 ⌋ ; \\ then RIV = {N}_{RB}^{UL} ( {L}_{CRBs} - 1 ) + {RB}_{START} \\ else \\ RIV = {N}_{RB}^{UL} ( {N}_{RB}^{UL} - {L}_{CRBs} + 1 ) + ( {N}_{RB}^{UL} - 1 - {RB}_{START} ) \qquad [ Eqn . 5 ]$$

SS 116 discards PUSCH resource allocation in the corresponding PDCCH with DCI format 0 if consistent control information is not detected.

If the Hopping-mode is “inter-subframe”, the 1^{st} slot RA is applied to even CURRENT_TX_NB, and the 2^{nd} slot RA is applied to odd CURRENT_TX_NB, where CURRENT_TX_NB is “a state variable, which indicates the number of transmissions that have taken place for the MAC PDU currently in the buffer” as defined in 3GPP TS36.321, “Evolved Universal Terrestrial Radio Access (E-UTRA); Medium Access Control (MAC) protocol specification”, the contents of which are hereby incorporated by reference in their entirety.

For a second type of hopping, Type 2 PUSCH Hopping, the set of physical resource blocks to be used for transmission in slot nₛ is given by the scheduling grant together with a predefined pattern as defined below. If the system frame number is not acquired by SS 116 yet, SS 116 does not transmit PUSCH with type-2 hopping and N_{sb}>1 for TDD, where N_{sb} is provided by high layers. In Type 2 PUSCH hopping, the hopping bandwidth is virtually divided into sub-bands of equal width. Each sub-band constitutes a number of contiguous resource blocks.

In addition to hopping, SS 116 can also perform mirroring as a function of the slot number. The hopping and mirroring patterns are cell-specific. Thus Type 2 PUSCH hopping can also be referred to as “sub-band based hopping according to cell-specific hopping/mirroring patterns”

If uplink frequency-hopping with predefined hopping pattern is enabled, the set of physical resource blocks to be used for transmission in slot nₛ is given by the scheduling grant together with a predefined pattern according to Equation set 6:

$${\tilde{n}}_{PRB} ( {n}_{s} ) = ( \begin{matrix}{\tilde{n}}_{VRB} + {f}_{hop} ( i ) \cdot {N}_{RB}^{sb} + \\ ( ( {N}_{RB}^{sb} - 1 ) - 2 ( {\tilde{n}}_{VRB} mod {N}_{RB}^{s b} ) ) \cdot {f}_{m} ( i )\end{matrix} ) mod ( {N}_{RB}^{s b} \cdot {N}_{sb} ) \\ i = \{ \begin{matrix}⌊ {n}_{S} / 2 ⌋ & inter \text{-} subframe hopping \\ {n}_{s} & intra and inter \text{-} subframe hopping\end{matrix} \\ {n}_{PRB} ( {n}_{s} ) = \{ \begin{matrix}{\tilde{n}}_{PRB} ( {n}_{s} ) & {N}_{sb} = 1 \\ {\tilde{n}}_{PRB} ( {n}_{s} ) + ⌈ {N}_{RB}^{HO} / 2 ⌉ & {N}_{sb} > 1\end{matrix} \\ {\tilde{n}}_{VRB} = [ \begin{matrix}{n}_{VRB} & {N}_{sb} = 1 \\ {n}_{VRB} - ⌈ {N}_{RB}^{HO} / 2 ⌉ & {N}_{sb} > 1\end{matrix} ] \qquad [ Eqn . 6 ]$$

In Equation set 6, n_{VRB} is obtained from the scheduling grant as described above. The parameter pusch-HoppingOffset,

$${N}_{RB}^{HO} ,$$

is provided by higher layers. The size

$${N}_{RB}^{sb}$$

of each sub-band is given by Equation 7:

$${N}_{RB}^{sb} = \{ \begin{matrix}{N}_{RB}^{UL} & {N}_{sb} = 1 \\ ⌊ ( {N}_{RB}^{UL} - {N}_{RB}^{HO} - {N}_{RB}^{HO} mod 2 ) / {N}_{sb} ⌋ & {N}_{sb} > 1\end{matrix} \qquad [ Eqn . 7 ]$$

In Equation 7, the number of sub-bands N_{sb} is given by higher layers. The function ƒₘ(i)ε{0, 1} determines whether mirroring is used or not. The parameter Hopping-mode provided by higher layers determines if hopping is “inter-subframe” or “intra and inter-subframe”.

The hopping function ƒₕₒₚ(i) and the function ƒₘ(i) are given by Equations 8 and 9:

$$\begin{matrix} {f}_{hop} ( i ) = \{ \begin{matrix}0 & {N}_{sb} = 1 \\ ( \begin{matrix}{f}_{hop} ( i - 1 ) + \\ {\sum }_{k = i \cdot 10 + 1}^{i \cdot 10 + 9} c ( k ) \times {2}^{k - ( i \cdot 10 + 1 )}\end{matrix} ) mod {N}_{sb} & {N}_{sb} = 2 \\ ( \begin{matrix}{f}_{hop} ( i - 1 ) + \\ \begin{matrix}( {\sum }_{k = i \cdot 10 + 1}^{i \cdot 10 + 9} c ( k ) \times {2}^{k - ( i \cdot 10 + 1 )} ) \\ mod ( {N}_{sb} - 1 ) + 1\end{matrix}\end{matrix} ) mod {N}_{sb} & {N}_{s b} > 2\end{matrix} & [ Eqn . 8 ] \\ {f}_{m} ( i ) = \{ \begin{matrix}i mod 2 & \begin{matrix}{N}_{sb} = 1 and intra and \\ inter \text{-} subframehopping\end{matrix} \\ CURRENT\_TX \_NBmod2 & \begin{matrix}{N}_{sb} = 1 and \\ inter \text{-} subframehopping\end{matrix} \\ c ( i \cdot 10 ) & {N}_{sb} > 1\end{matrix} & [ Eqn . 9 ]\end{matrix}$$

In Equations 8 and 9, ƒₕₒₚ(−1)=0 and the pseudo-random sequence c(i) is given by section 7.2 and CURRENT_TX_NE indicates the transmission number for the transport block transmitted in slot nₛ as defined in Evolved Universal Terrestrial Radio Access (E-UTRA); Medium Access Control (MAC) protocol specification. The pseudo-random sequence generator shall be initialized with

$${c}_{init} = {N}_{ID}^{cell}$$

for frame structure type 1 and

$${c}_{init} = {2}^{9} \cdot ( {n}_{f} mod 4 ) + {N}_{ID}^{cell}$$

for frame structure type 2 at the start of each frame.

In certain examples, the above PUSCH hopping is on the whole contiguous system bandwidth.

In addition, in the LTE downlink, a virtual resource block (VRB) concept is defined to enable distributed transmissions. A VRB is the same size as a physical resource block. Resource blocks are used to describe the mapping of certain physical channels to resource elements. A physical resource block is defined in 3GPP 36.211, “Universal Terrestrial Radio Access (E-UTRA); Physical Channels and Modulation”, the contents of which are hereby incorporated by reference in their entirety.

Two types of virtual resource blocks are: 1) Virtual resource blocks of localized type; and 2) Virtual resource blocks of distributed type. For each type of virtual resource blocks, a pair of virtual resource blocks over two slots in a subframe is assigned together by a single virtual resource block number, n_{VRB}, which is a set of RB indices, such as, n_{VRB}={1, 2}.

Virtual resource blocks of localized type are mapped directly to physical resource blocks such that virtual resource block n_{VRB} corresponds to physical resource block n_{PRB}=n_{VRB}. Virtual resource blocks are numbered from 0 to

$${N}_{VRB}^{DL} - 1 ,$$

where

$${N}_{VRB}^{DL} = {N}_{RB}^{DL} .$$

Virtual resource blocks of distributed type are mapped to physical resource blocks as follows. The parameter N_{gap} is given by Table 6.2.3.2-1 of Universal Terrestrial Radio Access (E-UTRA); Physical Channels and Modulation. For

$$6 \leq {N}_{RB}^{DL} \leq 49 ,$$

only one gap value, N_{gap,1}, is defined and N_{gap}=N_{gap,1}. For

$$50 \leq {N}_{RB}^{DL} \leq 110 ,$$

two gap values, N_{gap,1} and N_{gap,2}, are defined. Whether N_{gap}=N_{gap,1} or N_{gap}=N_{gap,2} is signaled as part of the downlink scheduling assignment as described in 3GPP TS 36.211: “Evolved Universal Terrestrial Radio Access (E-UTRA); Physical channels and modulation”, the contents of which are hereby incorporated by reference in their entirety.

Virtual resource blocks of distributed type are numbered from

$$0 to {N}_{VRB}^{DL} - 1 ,$$

where

$${N}_{VRB}^{DL} = {N}_{VRB , gap 1}^{DL} = 2 \cdot min ( {N}_{gap} , {N}_{RB}^{DL} - {N}_{gap} )$$

### for N_{gap}=N_{gap,1} and

$${N}_{VRB}^{DL} = {N}_{VRB , gap 2}^{DL} = ⌊ {N}_{RB}^{DL} / 2 {N}_{gap} ⌋ \cdot 2 {N}_{gap}$$

### for N_{gap}=N_{gap,2}. Consecutive

$${\tilde{N}}_{VRB}^{DL}$$

VRB numbers compose a unit of VRB number interleaving, where

$${\tilde{N}}_{VRB}^{DL} = {N}_{VRB}^{DL}$$

### for N_{gap}=N_{gap,1} and

$${\tilde{N}}_{VRB}^{DL} = 2 {N}_{gap}$$

for N_{gap}=N_{gap,2}. Interleaving of VRB numbers of each interleaving unit is performed with 4 columns and N_{row} rows, where

$${N}_{row} = ⌈ {\tilde{N}}_{VRB}^{DL} / ( 4 P ) ⌉ \cdot P ,$$

and P is RBG size as described in 3GPP TS36.321, “Evolved Universal Terrestrial Radio Access (E-UTRA); Medium Access Control (MAC) protocol specification”, the contents of which are hereby incorporated by reference in their entirety. VRB numbers are written row by row in the rectangular matrix, and read out column by column. Nₙᵤₗₗ nulls are inserted in the last Nₙᵤₗₗ/2 rows of the 2^{nd} and 4^{th} column, where

$${N}_{null} = 4 {N}_{row} - {\tilde{N}}_{VRB}^{DL} .$$

Nulls are ignored when reading out. The VRB numbers mapping to PRB numbers including interleaving is derived according to Equations 10 through 14:

For even slot number nₛ;

$${\tilde{n}}_{PRB} ( {n}_{s} ) = \{ \begin{matrix}{\tilde{n}}_{PRB}^{′} - {N}_{row} , & {N}_{null} \neq 0 and \\ & {\tilde{n}}_{VRB} \geq {\tilde{N}}_{VRB}^{DL} - {N}_{null} and \\ & {\tilde{n}}_{VRB} mod 2 = 1 \\ {\tilde{n}}_{PRB}^{′} - {N}_{row} + {N}_{null} / 2 , & {N}_{null} \neq 0 and \\ & {\tilde{n}}_{VRB} \geq {\tilde{N}}_{VRB}^{DL} - {N}_{null} and \\ & {\tilde{n}}_{VRB} mod 2 = 0 \\ {\tilde{n}}_{PRB}^{″} - {N}_{null} / 2 , & {N}_{null} \neq 0 and \\ & {\tilde{n}}_{VRB} < {\tilde{N}}_{VRB}^{DL} - {N}_{null} and \\ & {\tilde{n}}_{VRB} mod 4 \geq 2 \\ {\tilde{n}}_{PRB}^{″} , & otherwise\end{matrix} \qquad [ Eqn . 10 ]$$

In Equation 10:

$${\tilde{n}}_{PRB}^{′} = 2 {N}_{row} \cdot ( {\tilde{n}}_{VRB} mod 2 ) + ⌊ {\tilde{n}}_{VRB} / 2 ⌋ + {\tilde{N}}_{VRB}^{DL} \cdot ⌊ {n}_{VRB} / {\tilde{N}}_{VRB}^{DL} ⌋ , \qquad [ Eqn . 11 ]$$

and:

$${\tilde{n}}_{PRB}^{″} = {N}_{row} \cdot ( {\tilde{n}}_{VRB} mod 4 ) + ⌊ {\tilde{n}}_{VRB} / 4 ⌋ + {\tilde{N}}_{VRB}^{DL} \cdot ⌊ {n}_{VRB} / {\tilde{N}}_{VRB}^{DL} ⌋ , \qquad [ Eqn . 12 ]$$

where

$${\tilde{n}}_{VRB} = {n}_{VRB} mod {\tilde{N}}_{VRB}^{DL}$$

and n_{VRB} is obtained from the downlink scheduling assignment as described in Evolved Universal Terrestrial Radio Access (E-UTRA); Medium Access Control (MAC) protocol specification.

For odd slot number nₛ;

$${\tilde{n}}_{PRB} ( {n}_{s} ) = ( {\tilde{n}}_{PRB} ( {n}_{s} - 1 ) + {\tilde{N}}_{VRB}^{DL} / 2 ) mod {\tilde{N}}_{VRB}^{DL} + {\tilde{N}}_{VRB}^{DL} \cdot ⌊ {n}_{VRB} / {\tilde{N}}_{VRB}^{DL} ⌋ \qquad [ Eqn . 13 ]$$

Then, for all nₛ;

$${n}_{PRB} ( {n}_{s} ) = \{ \begin{matrix}{\tilde{n}}_{PRB} ( {n}_{s} ) , & {\tilde{n}}_{PRB} ( {n}_{s} ) < {\tilde{N}}_{VRB}^{DL} / 2 \\ {\tilde{n}}_{PRB} ( {n}_{s} ) + {N}_{gap} - {\tilde{N}}_{VRB}^{DL} / 2 , & {\tilde{n}}_{PRB} ( {n}_{s} ) \geq {\tilde{N}}_{VRB}^{DL} / 2\end{matrix} \qquad [ Eqn . 14 ]$$

The above definition of VRB is based on a contiguous system bandwidth.

To meet the performance requirements set forth for LTE-A, one theme is the incorporation in the system of new nodes with lower transmission power as compared to the usual macro eNBs. These new nodes (pico cells, home eNBs or femto cells, relays) change the topology of the system to a much more heterogeneous network with a completely new interference environment in which nodes of multiple classes “compete” for the same wireless resources.

In heterogeneous networks, the interference problem may become serious due to the introduction of low power nodes which leads to low geometries especially in the co-channel deployment scenarios. The low geometries seen in heterogeneous deployments necessitate the use of interference coordination for both control and data channels to enable robust operation. In the 3GPP RAN1 meetings, many interference coordination solutions such as resource partition and power control have been proposed.

Inter-Cell Interference Coordination (ICIC) based on soft frequency reuse for the allocation of RBs in adjacent cells can be used to mitigate the inter-cell interference experienced by subscriber stations located near the cell edge. The allocation of some RBs to each cell for exclusive use by cell-edge subscriber stations can be through semi-static or dynamic network coordination taking into account the distribution (location and/or transmit power requirements) and throughput requirements of subscriber stations.

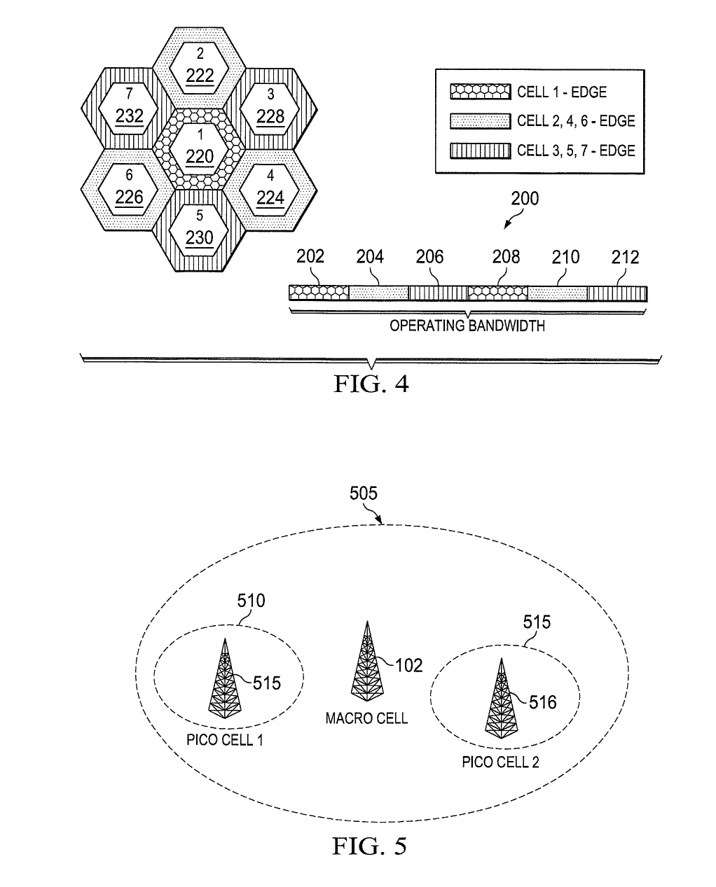

FIG. 4 illustrates Inter-cell Interference Coordination according to the disclosure. The example of the ICIC shown in FIG. 4 is for illustration only. Other examples could be used without departing from the scope of this disclosure.

The UL operating bandwidth (BW) 400 is divided into six sets of RBs 402-412, where the first 402 and fourth 408 sets are allocated to cell edge subscriber stations of cell-1 420. A cell edge subscriber station is a subscriber station located at or near a boundary (e.g., area) where two cells meet or overlap. The second 404 and fifth 410 sets are allocated to cell edge subscriber stations of cell-2 422, cell-4 424, and cell-6 426, and the third 406 and sixth 412 sets are allocated to cell-edge subscriber stations of cell-3 428, cell-5 430, and cell-7 432. The RB sets 402-412 may not be contiguous due to implementation reasons or in order to maximize frequency diversity. A base station may use the RBs over the entire UL operating BW to schedule PUSCH transmissions from cell-interior subscriber stations but may only use the allocated sets of RBs to schedule PUSCH transmissions to cell-edge subscriber stations.

FIG. 5 illustrates a heterogeneous network according to the disclosure. The example of the heterogeneous network 500 shown in FIG. 5 is for illustration only. Other examples could be used without departing from the scope of this disclosure.

ICIC can be particularly beneficial in heterogeneous network 500 where the macro-cell 505 served by a macro-BS 102 encompasses micro-cells 510, 515 served by respective micro-BS 512, 516. As the BS 102 covers a larger area than a BS 512, 516, a subscriber station, such as SS 116 (a macro-UE), connected to the BS 102 may transmit its signals with substantially higher power than a subscriber station, such as SS 115 (a micro-UE) connected to one of BS 512 or BS 516. SS 116 can therefore cause significant interference to SS 115, especially if both are located near the edge of a micro-cell 510, 515.

With conventional uplink PUSCH hopping, PUSCH may hop over the whole system bandwidth. This is clearly inefficient in case of ICIC as PUSCH for cell-interior subscriber stations should hop over substantially the entire operating BW for PUSCH transmissions while PUSCH for cell-edge subscriber stations should be distributed in a part of the operating BW. Even more importantly, in case of heterogeneous networks, allowing PUSCH transmission to macro-UEs, such as SS 116, to hop over the entire operating BW can create significant interference to the UL transmissions to micro-UEs, such as SS 115. Furthermore, in the heterogeneous network 500, when SS 116 (a macro-UE) is close to micro cell 510 or micro cell 515, allowing PUSCH transmission to SS 115 (a micro-UE) to hop over the entire operating BW can also create significant interference to the UL transmission of the SS 115. Therefore, it is beneficial to enable hopping of PUSCH with non-maximum transmission BW only in parts of the maximum configured system BW to avoid severe interference.

In addition, with conventional downlink distributed transmission, each VRB consists of RBs over the entire system bandwidth. This is inefficient in cases of ICIC as VRB for cell-interior subscriber stations should be distributed over substantially the entire operating BW for PDSCH transmissions while VRB for cell-edge subscriber stations should be distributed in a part of the operating BW. Even more importantly, in case of the heterogeneous network 500, allowing VRB transmission to SS 116 (macro-UE) to hop over the entire operating BW also can create significant interference to the DL transmissions to SS 115 (micro-UE). Furthermore, in the heterogeneous network 500, when SS 116 (macro-UE) is close to a micro cell and allowing VRB transmission to SS 115 (micro-UE) to hop over the entire operating BS can also create significant interference to the DL transmission of the SS 116. Therefore, it is beneficial to perform a PUSCH frequency hopping of the VRB with non-maximum transmission BW only in parts of the maximum configured system BW to avoid severe interference.

Accordingly, certain embodiments of the present disclosure enable PUSCH hopping over non-contiguous BWs in an operating BW. Certain embodiments enable VRB transmissions over non-contiguous BW in an operating BW. Additionally, certain embodiments enable PUSCH hopping over a BW smaller than the maximum operating BW. Further, certain embodiments enable VRB hopping over a BW smaller than the maximum operating BW.

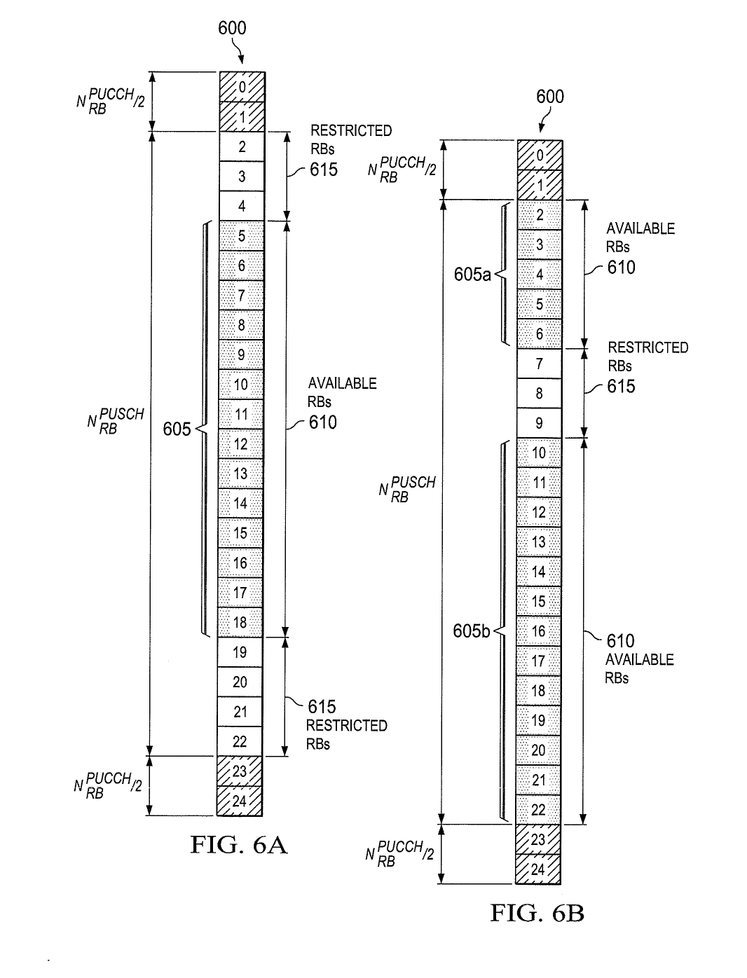

FIG. 6A illustrates a subset of resource blocks used for physical uplink shared channel hopping for a contiguous bandwidth according to embodiments of the present disclosure. FIG. 6B illustrates a subset of resource blocks used for physical uplink shared channel hopping for a non-contiguous bandwidth according to embodiments of the present disclosure. The embodiments of the subsets of resource blocks shown in FIGS. 6A and 6B are for illustration only. Other embodiments could be used without departing from the scope of this disclosure.

For convenience of explanation, in the examples illustrated herein, RBs used for PUSCH hopping are references as active or available RBs. Additionally, RBs that should not be used for PUSCH hopping are referenced as restricted RBs or non-available RBs.

In some embodiments, the set of RBs used for PUSCH hopping can be contiguous as shown in FIG. 6A. The PUSCH hopping occurs within a contiguous subset 605 of RBs in the PUSCH bandwidth 600 rather than the entire PUSCH bandwidth 600. FIG. 6A illustrates an example of a subset 605 of RBs used for PUSCH hopping where

$${N}_{RB}^{PUCCH}$$

is the number of RBs used for PUCCH, e.g., control channel, transmission and is the same as

$${N}_{RB}^{HO} .$$

The subset 605 of RBs used for PUSCH hopping are the RBs marked as available RBs 610. The restricted RBs 615 are RBs used by neighbor cells, such as Femto cells. For example, the PUSCH transmission only hops within the subset 605 of available RBs 610.

In some embodiments, the set of RBs used for PUSCH hopping can be non-contiguous as shown in FIG. 6B. The PUSCH hopping occurs within at least two non-contiguous subsets 605a-605b of RBs in the PUSCH bandwidth 600 rather than the entire PUSCH bandwidth 600. Although two non-contiguous subsets 605a-605b are shown in FIG. 6B, more than two non-contiguous subsets could be used without departing from the scope of this disclosure. FIG. 6B illustrates an example of at least two subsets 605a-605b of RBs used for PUSCH hopping where

$${N}_{RB}^{PUCCH}$$

is the number of RBs used for PUSCH transmission and is the same as

$${N}_{RB}^{HO} .$$

The subsets 605a-605b of RBs used for PUSCH hopping are the RBs marked as available RBs 610. The restricted RBs 615 are RBs used by neighbor cells, such as Femto cells. For example, the PUSCH transmission only hops within the subsets 605a-605b of available RBs 610.

In some embodiments, BS 102 uses a signaling to notify SS 116 regarding the subset 605 of RBs used for PUSCH hopping. The signaling can be a high-layer semi-static signaling or a dynamic signaling. For example, the subset 605 of RBs used for PUSCH hopping, such as, the indices of the available RBs 610, can be signaled to SS 116 by BS 102 using radio resource control (RRC) signaling or broadcast message.

In some embodiments, BS 102 uses a signaling to notify a SS 116 regarding the restricted RBs 615 that SS 116 should not use for PUSCH hopping. The signaling can be a high-layer semi-static signaling or a dynamic signaling. For example, the subset or subsets of RBs that should not be used for PUSCH transmission, such as the restricted RBs 615, is signaled to SS 116 by BS 102 using RRC signaling or broadcast message.

In some embodiments, when the subset 605 of available RBs is contiguous, high-layer signaling, such as a UE-specific RRC message, is used to notify SS 116 regarding the starting position of the set of available RBs as well as the number of RBs within it. In one example the starting position is referenced to be

$${RB}_{START}^{ACT}$$

and the length of the available RBs

$${N}_{RB}^{ACT} .$$

### Then

$${RB}_{START}^{ACT}$$

and

$${N}_{RB}^{ACT}$$

can be sent to SS 116 using UE-specific RRC signaling in either a coded or an un-coded method. For example, in FIG. 6A,

$${RB}_{START}^{ACT} = 5$$

and

$${N}_{RB}^{ACT} = 14.$$

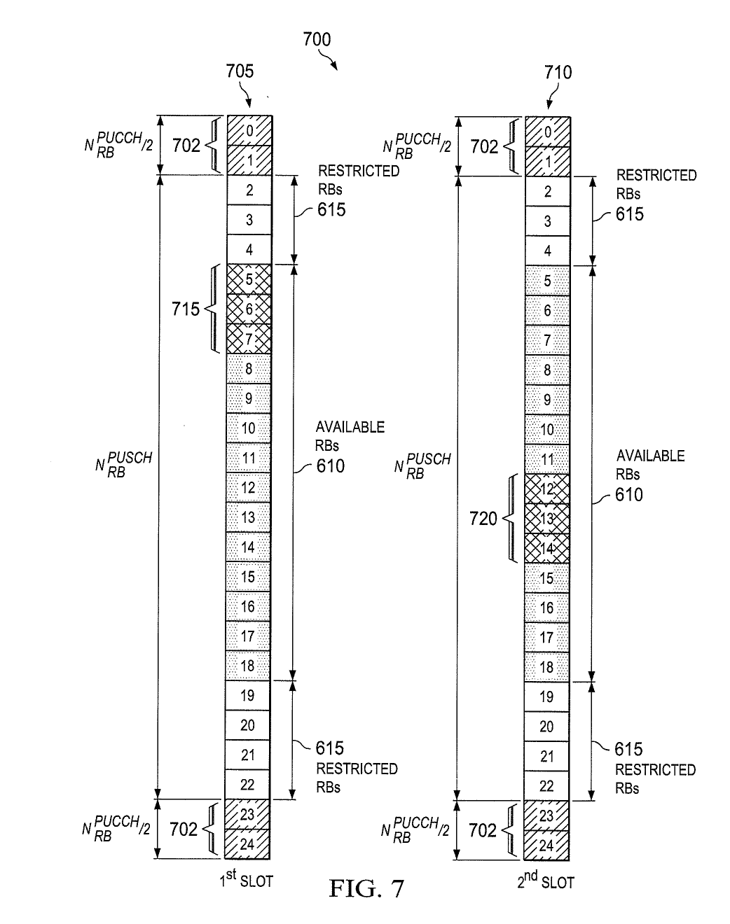

FIG. 7 illustrates example resource assignments for slots according to embodiments of the present disclosure. The embodiment of the resource assignments shown in FIG. 7 is for illustration only. Other embodiments could be used without departing from the scope of this disclosure.

In the example shown in FIG. 7, a sub-frame 700 includes a first slot 705 and a second slot 710. When a subset of available RBs 610 is contiguous and hopping is applied, the assigned RB indices of the 1^{st} slot is the same as that of Type-I hopping discussed herein above, and the RB indices applied for the 2^{nd} slot is an offset compared to the indices of RBs used for PUSCH transmission in 1^{st} slot. The offset can be a function of the number of available RBs, that is,

$$f ( {N}_{RB}^{ACT} ) .$$

If the Hopping-mode is “inter-sub-frame”, the proposed 1^{st} slot resource allocation (RA) is applied to even CURRENT_TX_NB, and the proposed 2^{nd} slot RA is applied to odd CURRENT_TX_NB, where CURRENT_TX_NB is a state variable, which indicates the number of transmissions that have taken place for the MAC PDU currently in the buffer.

In the example shown in FIG. 7, in the 1^{st} slot 705: the lowest index PRB

$$( {n}_{PRB}^{S 1} ( i ) )$$

of the 1^{st} slot RA in sub-frame i is defined
as

$${n}_{PRB}^{S 1} ( i ) = {\tilde{n}}_{PRB}^{S} ( i ) + \frac{{\tilde{N}}_{RB}^{HO}}{2} ,$$

where

$${n}_{PRB}^{S 1} ( i ) = {RB}_{START} ,$$

and RB_{START} is obtained from the uplink scheduling grant. The set of physical resource blocks to be used for PUSCH transmission are L_{CRBs} contiguously allocated resource blocks from PRB index

$${n}_{PRB}^{S 1} ( i ) .$$

In the 2^{nd} slot 710: the lowest index PRB (n_{PRB}(i)) of the 2^{nd} slot RA in sub-frame i is

$${n}_{PRB}^{S 1} ( i ) ,$$

either plus or minus or ½ or ¼ of the number of available RBs,

$${N}_{RB}^{ACT} .$$

### Mathematically,

$${n}_{PRB} ( i ) = {\tilde{n}}_{PRB} ( i ) + \frac{{\tilde{N}}_{RB}^{HO}}{2} ,$$

where ñ_{PRB}(i) is one of the following:

$$\begin{matrix}a ) . ( ⌊ \frac{{N}_{RB}^{ACT}}{2} ⌋ + {\tilde{n}}_{PRB}^{S 1} ( i ) ) mod {N}_{RB}^{ACT} + {RB}_{START}^{ACT} & [ Eqn . 15 ] \\ b ) . ( ⌊ \frac{{N}_{RB}^{ACT}}{4} ⌋ + {\tilde{n}}_{PRB}^{S 1} ( i ) ) mod {N}_{RB}^{ACT} + {RB}_{START}^{ACT} & [ Eqn . 16 ] \\ c ) . ( - ⌊ \frac{{N}_{RB}^{ACT}}{4} ⌋ + {\tilde{n}}_{PRB}^{S 1} ( i ) ) mod {N}_{RB}^{ACT} + {RB}_{START}^{ACT} & [ Eqn . 17 ] \\ d ) . ( - ⌊ \frac{{N}_{RB}^{ACT}}{2} ⌋ + {\tilde{n}}_{PRB}^{S 1} ( i ) ) mod {N}_{RB}^{ACT} + {RB}_{START}^{ACT} & [ Eqn . 18 ]\end{matrix}$$

The set of physical resource blocks to be used for PUSCH transmission are L_{CRBs} contiguously allocated resource blocks from PRB index n_{PRB}(i). In the example shown in FIG. 7, in the first slot 705, the start resource block is “3” resource blocks from the control channel resource blocks, the control channel (PUCCH) RB's 702 are “4” (half of which is “2” since the subscriber station transmits half the control channel on each end of the slot) and the size of the subset 605 is “4”. Therefore, L_{CRBs}=3 and

$${\tilde{N}}_{RB}^{HO} = 4$$

(half of which is “2”), RB_{START}=3,

$${\tilde{n}}_{PRB}^{S 1} ( i ) = 3 + 2 = 5$$

and Equation 15 is used for calculating ñ_{PRB}(i), which is used to determine the starting RB for the second slot 710. Therefore, the RBs used for PUSCH transmission are RBs 715, 720.

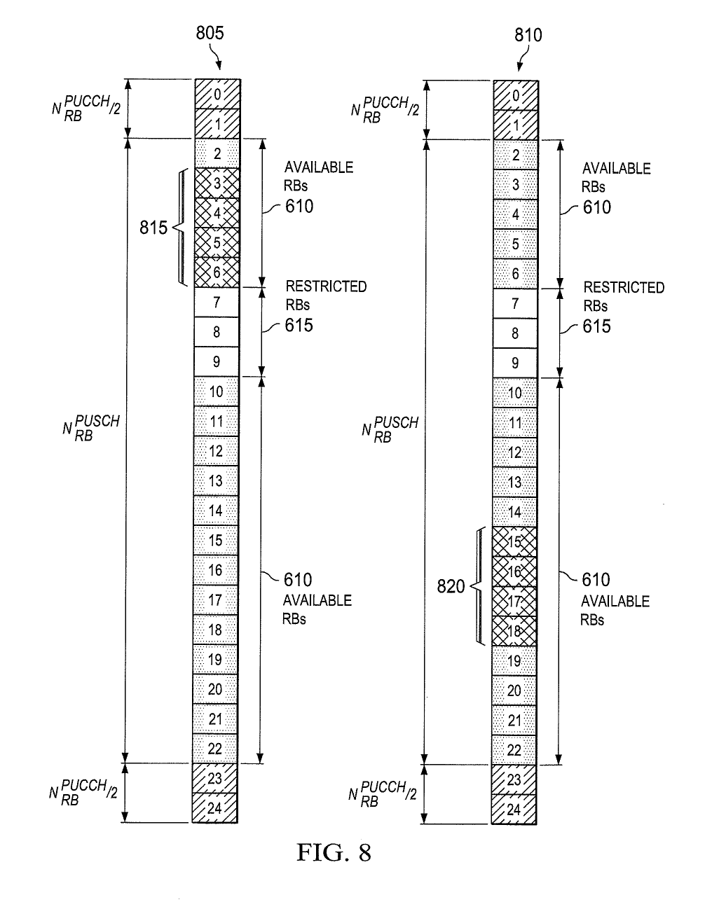

FIG. 8 illustrates resource assignments for slots issued in the scheduling grant according to embodiments of the present disclosure. The embodiment of the resource assignments shown in FIG. 8 is for illustration only. Other embodiments could be used without departing from the scope of this disclosure.

In the example shown in FIG. 8, the resource assignments for the two slots 805, 810 in a sub-frame are provided in the scheduling grant respectively. That is, the resource assignments for the two slots 805, 810 in a sub-frame are provided independently. For example, the two lowest index PRBs for the two slots 805, 810 and the number of contiguously allocated RBs can be provided in the scheduling grant. If the Hopping-mode is “inter-subframe”, the 1^{st} slot RA is applied to even CURRENT_TX_NB, and the 2^{nd} slot RA is applied to odd CURRENT_TX_NB, where CURRENT_TX_NB is a state variable, which indicates the number of transmissions that have taken place for the MAC PDU currently in the buffer.

For example, the lowest index PRBs

$$( {n}_{PRB}^{S 1} ( i ) , {n}_{PRB}^{S 2} ( i ) )$$

of the 1^{st} and 2^{nd} slot RAs in sub-frame i is defined as

$${n}_{PRB}^{S 1} ( i ) = {\tilde{n}}_{PRB}^{S 1} ( i ) + \frac{{\tilde{N}}_{RB}^{HO}}{2}$$

and

$${n}_{PRB}^{S 2} ( i ) = {\tilde{n}}_{PRB}^{S 2} ( i ) + \frac{{\tilde{N}}_{RB}^{HO}}{2} ,$$

where

$${n}_{PRB}^{S 1} ( i ) = {RB}_{START 1} , \\ {n}_{PRB}^{S 2} ( i ) = {RB}_{START 2} ,$$

and RB_{START1} and RB_{START2} are obtained from the uplink scheduling grant. The set of physical resource blocks to be used for PUSCH transmission are L_{CRBs} contiguously allocated resource blocks from PRB index

$${n}_{PRB}^{S 1} ( i )$$

and

$${n}_{PRB}^{S 2} ( i )$$

respectively for the two slots 805, 810. In the example shown in FIG. 8,

$${\tilde{N}}_{RB}^{HO} = 4 ,$$

### RB_{START1}=1, RB_{START2}=13, and L_{CRBs}=4.

In one example, the lowest index PRB

$$( {n}_{PRB}^{S 1} ( i ) )$$

of the 1^{st} in sub-frame is defined as

$${n}_{PRB}^{S 1} ( i ) = {\tilde{n}}_{PRB}^{S 1} ( i ) + \frac{{\tilde{N}}_{RB}^{HO}}{2} ,$$

where

$${n}_{PRB}^{S 1} ( i ) = {RB}_{START 1}$$

and RB_{START1} is obtained from the uplink scheduling grant. The lowest index PRB

$$( {n}_{PRB}^{S 2} ( i ) )$$

of the 2^{nd} in sub-frame i is defined as

$${n}_{PRB}^{S 2} ( i ) = {\tilde{n}}_{PRB}^{S 1} ( i ) + \frac{{\tilde{N}}_{RB}^{HO}}{2} + offset ,$$

where Offset is obtained from either the uplink scheduling grant together with RB_{START1} or from a high layer signaling. The set of physical resource blocks to be used for PUSCH transmission are L_{CRBs} contiguously allocated resource blocks from PRB index

$${n}_{PRB}^{S 1} ( i )$$

and

$${n}_{PRB}^{S 2} ( i )$$

respectively for the two slots 805, 810. In the example shown in FIG. 8,

$${\tilde{N}}_{RB}^{HO} = 4 ,$$

RB_{START1}=1, Offset=12, and L_{CRBs}=4. Therefore, the RBs used for PUSCH transmission are RBs 815, 820.

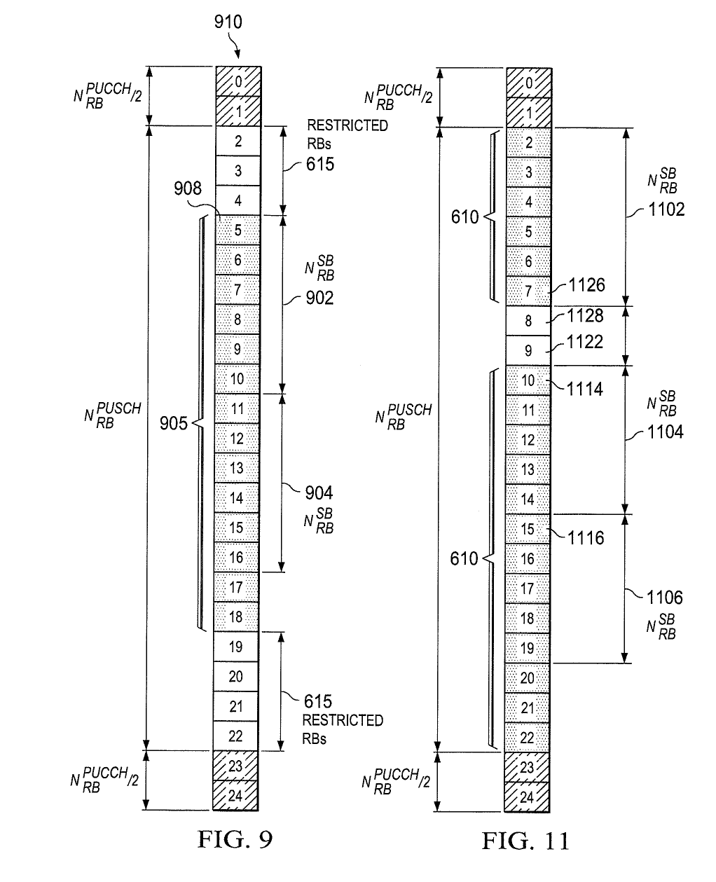

FIG. 9 illustrates a hopping start position and number of sub-bands signaled to the subscriber station via higher layer signaling according to embodiments of the present disclosure. Each sub-band includes the same number of RBs and the subscriber station determines the maximum number of RBs within each sub-band such that the most available RBs are included in the sub-bands. Although the embodiment of the signaling shown in FIG. 9 is for illustration only, other embodiments could be used without departing from the scope of this disclosure.

In the example shown in FIG. 9, the available resource blocks in sub-frame 900 (or slot within the sub-frame 900) are divided into equal sub-bands. In dividing the available RBs 905 into the sub-bands, the sub-bands are equal, whole-sized RBs. For example, if there are thirteen available RBs, and two sub-bands, each sub-band will include six RBs and one RB 906 will remain unused.

When Type-2 PUSCH hopping is used and the subset of available RBs 905 is contiguous, the starting position

$${RB}_{START}^{ACT}$$

910 of the subset of available RBs 905 and the number of sub-bands N_{sb} are signaled to SS 116 using high-layer signaling. In the example shown in FIG. 9,

$${RB}_{START}^{ACT} = 5$$

and N_{sb}=2. That is, SS 116 is instructed to start the RBs at the fifth RB 908 and divide the available RBS 610 into two equal sub-bands 902, 904.

In some embodiments, when Type-2 PUSCH hopping is used and the subset of available RBs 905 is contiguous, the starting position

$${RB}_{START}^{ACT}$$

910 of the subset of available RBs 905 and the number of RBs in each sub-band

$${N}_{RB}^{sb}$$

are signaled to SS 116 using high-layer signaling. In the example shown in FIG. 9,

$${RB}_{START}^{ACT} = 5$$

and

$${N}_{RB}^{sb} = 6.$$

In some embodiments, in PUSCH hopping based on sub-band, sub-bands of equal number RBs are defined only within the subset of available RBs 610 and each sub-band constitutes the same number of contiguous resource blocks. The locations of all sub-bands, such as, in terms of RB index, are signaled to SS 116 using high-layer signaling. The sub-band hopping is applied on the sub-bands defined within the subset of available RBs 610.

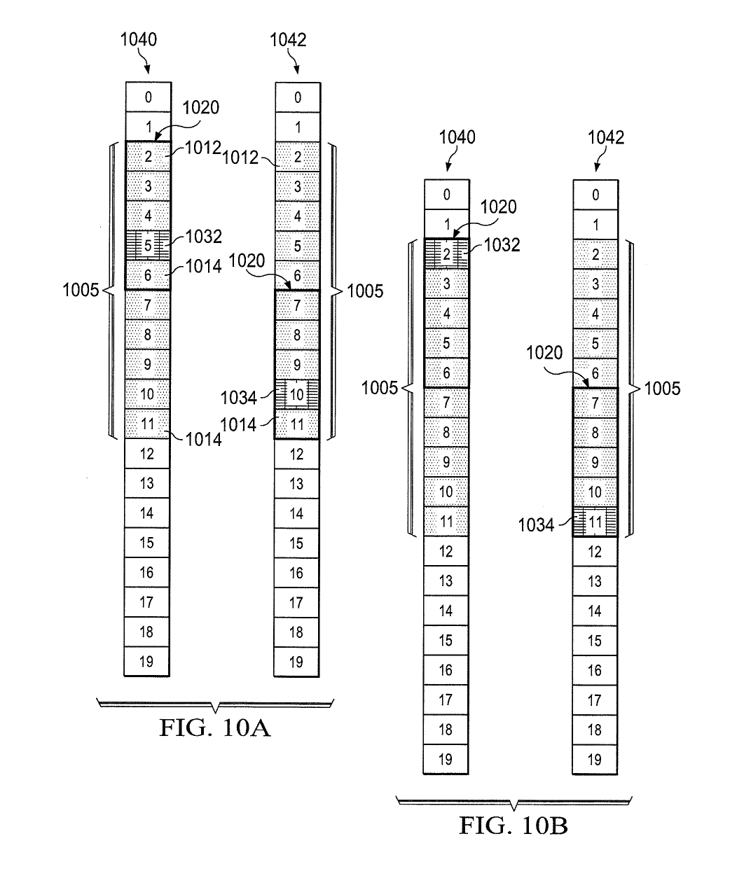

FIGS. 10A and 10B illustrate a Type-2 hopping function on the sub-bands within the subset of available RBs according to embodiments of the present disclosure. The embodiments of the hopping in FIGS. 10A and 10B are for illustration only. Other embodiments could be used without departing from the scope of this disclosure.

The Type-2 hopping function can be defined to be only on the sub-bands within the subset of available RBs. Therefore, the Type-2 hopping can be defined by Equation set 19:

$${\tilde{n}}_{PRB} ( {n}_{s} ) = ( {\tilde{n}}_{VRB} + {f}_{hop} ( i ) \cdot {N}_{RB}^{sb} + ( ( {N}_{RB}^{sb} - 1 ) - 2 ( {\tilde{n}}_{VRB} mod {N}_{RB}^{sb} ) ) \cdot {f}_{m} ( i ) ) mod ( {N}_{RB}^{sb} \cdot {N}_{sb} ) \\ i = \{ \begin{matrix}⌊ {n}_{s} / 2 ⌋ & inter \text{-} subframehopping \\ {n}_{s} & intraandinter \text{-} subframehopping\end{matrix} \\ {n}_{PRB} ( {n}_{s} ) = \{ \begin{matrix}{\tilde{n}}_{PRB} ( {n}_{s} ) & {N}_{sb} = 1 \\ {\tilde{n}}_{PRB} ( {n}_{s} ) + {RB}_{START}^{ACT} & {N}_{sb} > 1\end{matrix} \\ {\tilde{n}}_{VRB} = \{ \begin{matrix}{n}_{VRB} & {N}_{sb} = 1 \\ {\tilde{n}}_{VRB} - {RB}_{START}^{ACT} & {N}_{sb} > 1\end{matrix} \qquad [ Eqn . 19 ]$$

In Equation 19,

$${RB}_{START}^{ACT}$$

is the starting position of the subset of available RBs,

$${N}_{RB}^{sb}$$

is the number RBs in each sub-band, and N_{sb} is the number of sub-bands within the subset of available RBs. Others are the same as those in Rel-8. In the example shown in FIGS. 10A and 10B, the subset of available RBs 1005 is contiguous from RB#2 1012 through RB#11 1014. The sub-bands 1020 are marked for clarity with a bolded edge and are contiguous in a first set from RB#2 1012 through RB#6 1022 and a second set from RB#7 1024 through RB#11 1014. The RBs 1032, 1034 (cross-hatched for clarity) are those used for PUSCH transmission. The example in FIG. 10A illustrates the Type-2 hopping without mirroring and the example in FIG. 10B the Type-2 hopping with mirroring. In Type-2 hopping without mirroring, the RBs 1032 used for PUSCH transmission in the first slot 1040 sub-bands 1020 are applied as corresponding RBs 1034 in the second slot 1042 sub-bands 1020. In Type-2 hopping with mirroring, the RBs 1032 used for PUSCH transmission in the first slot 1040 sub-bands 1020 are applied as corresponding mirrored RBs 1034 in the second slot 1042 sub-bands 1020.

FIG. 11 illustrates a Type-2 hopping function on the sub-bands within the subset of available non-contiguous RBs according to embodiments of the present disclosure. The embodiment of the hopping in FIG. 11 is for illustration only. Other embodiments could be used without departing from the scope of this disclosure.

In Type-2 PUSCH hopping when the subset of available RBs is non-contiguous, all sub-bands 1102, 1104, 1106 are of the same number of RBs and the starting positions of all sub-bands, such as in terms of RB index, and the number of RBs in each sub-band 1102, 1104, 1106 are signaled to SS 116 using high-layer signaling. In the example shown in FIG. 11, the sub-band 1102, 1104, 1106 starting positions RB-2 1112, RB-10 1114, RB-15 1116 are signaled with the number of RBs in each sub-band 1102, 1104, 1106, (which is five) using high-layer signaling.

In some embodiments, using Type-2 PUSCH hopping, when the subset of available RBs 610 is non-contiguous, all sub-bands 1102, 1104, 1106 include the same number of RBs. Here, only the number of RBs within each sub-band is signaled to SS 116 using high-layer signaling. SS 116 calculates the positions of sub-bands 1102, 1104, 1106 based on the number of RBs within each sub-band,

$${N}_{RB}^{sb} ,$$

as well as which RBs are within the subset of available RBs 610. In the calculation, SS 116 determines that each sub-band 1102, 1104, 1106 starts from the first RB in the subset of available RBs 610 and if a sub-band includes non-available RBs 615, this sub-band should be excluded and the next sub-band should start from the first available RB after the last non-available RB. For example, as shown in FIG. 11, the number of RBs in each sub-band 1102, 1104, 1106 is five, which is signaled using high-layer signaling. In calculating the positions of each sub-band 1102, 1104, 1106, SS 116 starts from RB-2 1112. The second sub-band 1104 starts from RB-10 1114, which is the first available RB after the non-available RB-9 1122. The first sub-band 1102 ends at RB-6 1124. However, the next sub-band cannot start at RB-7 1126 because RB-8 1128 and RB-9 1122 are within the restricted RBs 615.

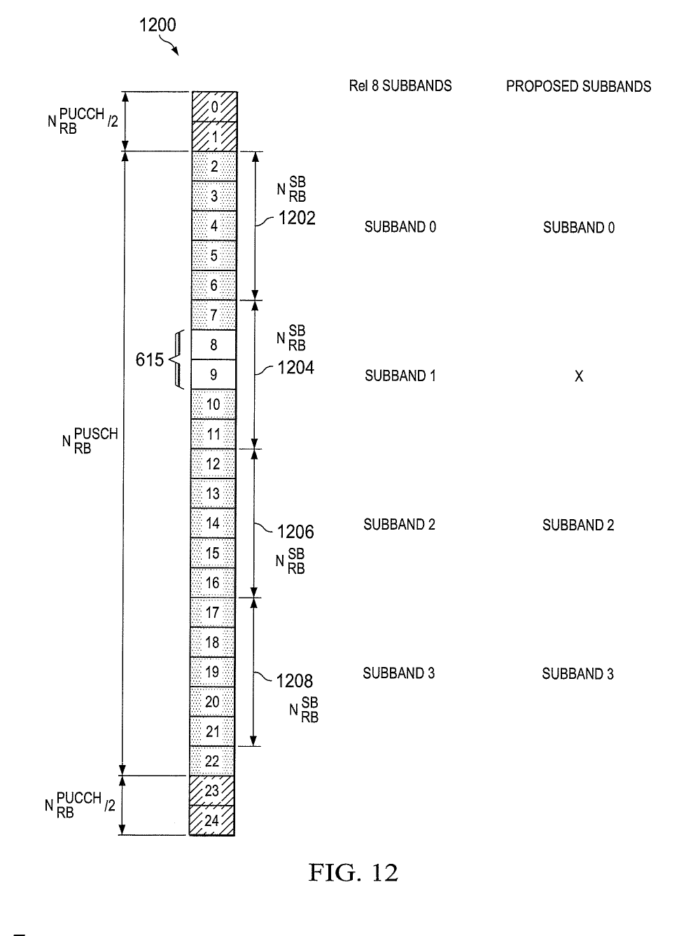

FIG. 12 illustrates a hopping in which the overall PUSCH bandwidth into a number of equal contiguous sub-bands according to embodiments of the present disclosure. The embodiment of the hopping shown in FIG. 12 is for illustration only. Other embodiments could be used without departing from the scope of this disclosure.

In the example shown in FIG. 12, the entire PUSCH resource blocks in sub-frame 1200 (or slot within the sub-frame 1200) are divided into equal sub-bands. Using Type-2 PUSCH hopping, the overall PUSCH system bandwidth is divided into sub-bands of equal width and each sub-band 1202, 1204, 1206, 1206 includes a number of contiguous resource blocks. The number of sub-bands is sent to SS 116 by high layers. In case a sub-band includes any restricted RB, this sub-band is not used in the hopping. In the example shown in FIG. 12, the number of RBs in each sub-band 1202, 1204, 1206, 1206, is five, which is signaled using high-layer signaling. The overall PUSCH system bandwidth is twenty-one and the number of sub-bands is four. Each sub-band includes five RBs and the second sub-band 1204 includes a restricted set of RBs 615. Therefore, the second sub-band 120 is not used in the PUSCH hopping.

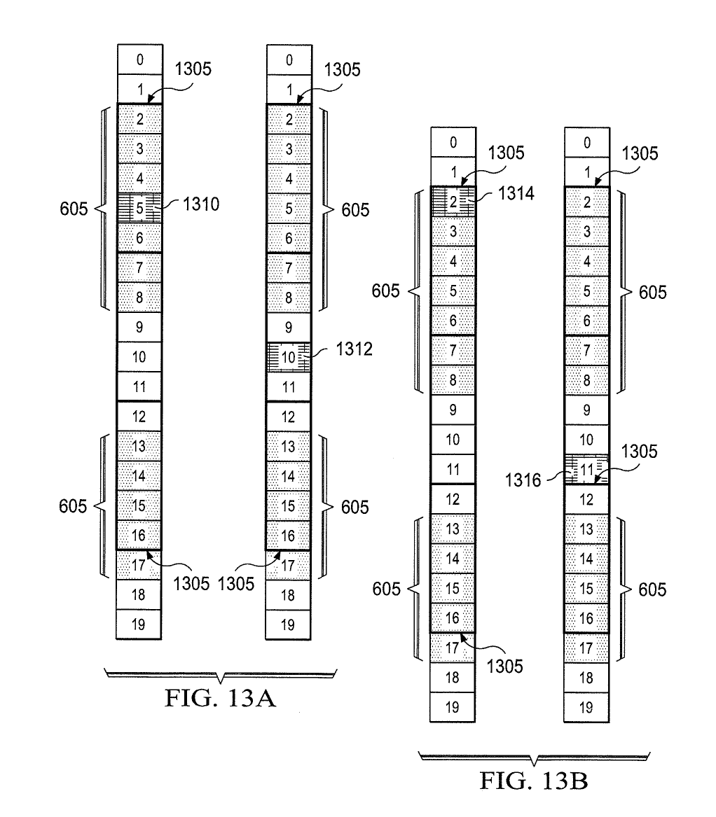

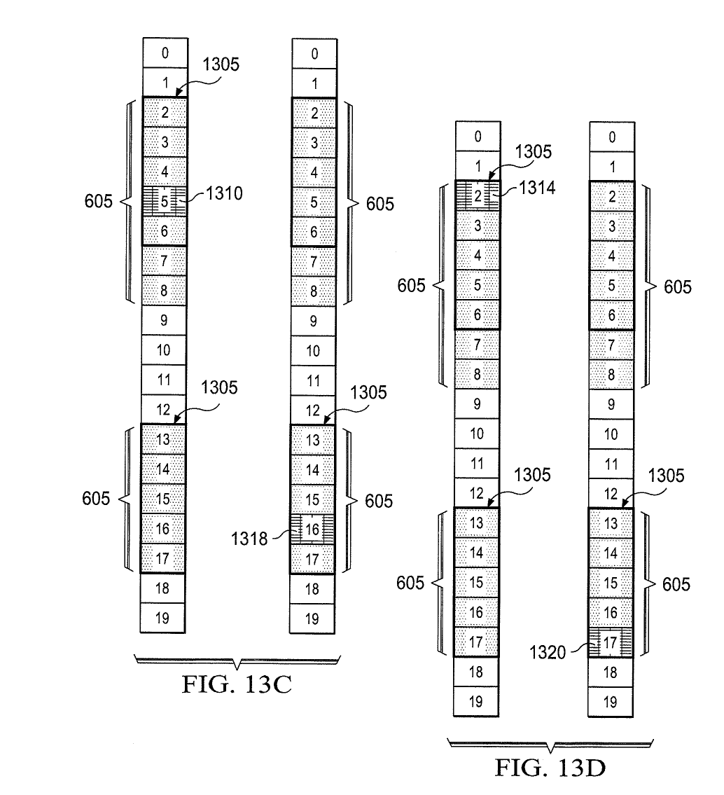

FIGS. 13A through 13D illustrate a Type-2 hopping function on the sub-bands within the subset of available non-contiguous RBs according to embodiments of the present disclosure.

The embodiments of the hopping in FIGS. 13A through 13D are for illustration only. Other embodiments could be used without departing from the scope of this disclosure.

In Type-2 PUSCH hopping that is based on sub-band, when the subset 605 of available RBs is non-contiguous, the starting positions of all sub-bands are signaled to SS 116 using high-layer signaling and the sub-band hopping is on the sub-bands defined within the available RBs 610.

In certain embodiments, the Type-2 hopping function is defined by Equation set 20:

$${\tilde{n}}_{PRB} ( {n}_{s} ) = {\tilde{n}}_{VRB} + RB ( {f}_{hop} ( i ) mod ( {N}_{sb} ) ) + ( ( {N}_{RB}^{sb} - 1 ) - 2 ( {\tilde{n}}_{VRB} {mod N}_{RB}^{sb} ) ) \cdot {f}_{m} ( i ) \\ i = \{ \begin{matrix}⌊ {n}_{s} / 2 ⌋ & inter \text{-} subframehopping \\ {n}_{s} & intraandinter \text{-} subframehopping\end{matrix} \\ {n}_{PRB} ( {n}_{s} ) = {\tilde{n}}_{PRB} ( {n}_{s} ) \\ {\tilde{n}}_{VRB} = {n}_{VRB} - RB ( 0 ) \qquad [ Eqn . 20 ]$$

In Equation 20, RB(k) is the starting RB of the k^{th} subband and N_{sb} is the number of sub-bands. Other elements are the same as those in Rel-8. FIGS. 13A through 13D illustrate two examples of the proposed hopping. For clarity only, the subsets 605 of available RBs are shaded and sub-bands 1305 are circled with bold lines. The RBs 1310, 1312, 1314, 1316, 1318, 1320 are those used for PUSCH transmission. FIGS. 13A and 13C illustrate examples for Type-2 hopping without mirroring and FIGS. 13B and 13D illustrate examples for Type-2 hopping with mirroring.

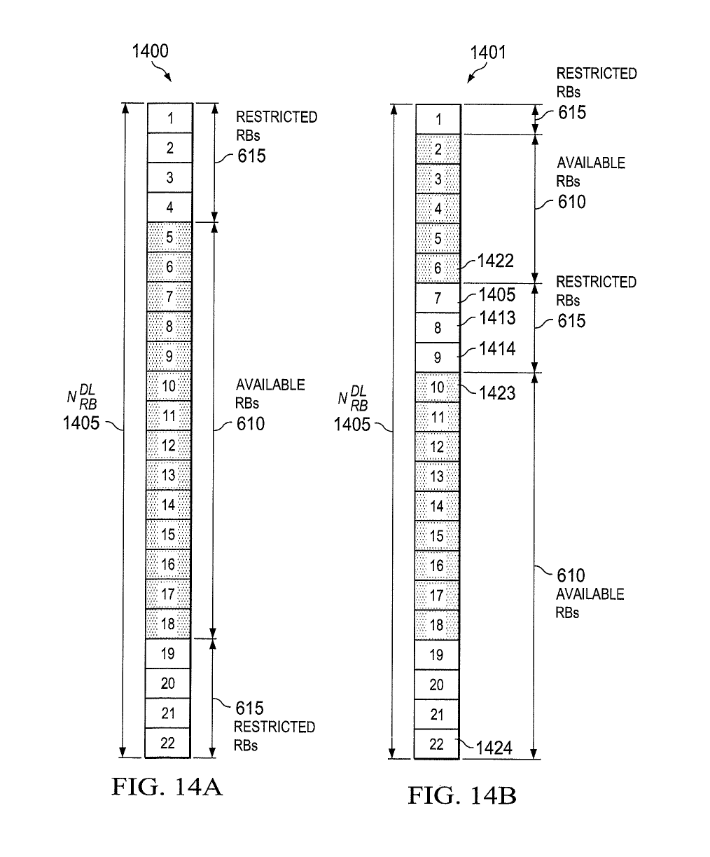

FIG. 14 illustrates a limited bandwidth for downlink communications according to embodiments of the present disclosure. The embodiments of the limited BWs shown in FIG. 14 are for illustration only. Other embodiments could be used without departing from the scope of this disclosure.

In some embodiments, BS 102 can signal the limited bandwidth to SS 116 and map the VRB into the limited bandwidth rather than the entire system bandwidth. In the examples shown in FIG. 14, the system bandwidth 1405 is

$${N}_{RB}^{DL}$$

RBs. The restricted RBs 615 are RBs used by neighbor cells and VRB can be distributed over the available RBs 610. In addition, the available bandwidth can be a contiguous bandwidth 1400 or a distributed bandwidth 1401.

For illustration purposes only, the physical resource blocks are numbered from “0” to

$${N}_{RB}^{DL} - 1$$

in the frequency domain. SS 116 is allowed to use a subset, Ñ_{PRB}, of these physical resources, called available physical resources/RBs. The number of elements in Ñ_{PRB} is

$${\tilde{N}}_{RB}^{DL} .$$

In one example, Ñ_{PRB}={0, 1, 2, 3, 4, 5, 6, 7, 8}, which is a continuous bandwidth, and

$${\tilde{N}}_{RB}^{DL} = 9.$$

In another example, Ñ_{PRB}={0, 1, 8, 9, 12, 13, 14, 15, 16, 20, 21}, which is a distributed bandwidth, and

$${\tilde{N}}_{RB}^{DL} = 11.$$

In another example,

$${\tilde{N}}_{PRB} = \{ 0 , 1 , 2 , K , {N}_{RB}^{DL} \} , {\tilde{N}}_{RB}^{DL} = {N}_{RB}^{DL} ,$$

and the entire bandwidth 1405 is available.

In some embodiments, when a limited bandwidth is used for PDSCH transmission rather than the entire system bandwidth 1405, BS 102 signals, semi-statically, the available physical resources, Ñ_{PRB}, or the restricted physical resources, to SS 116 using a signaling, such as UE-specific RRC signaling.

In some embodiments, when the limited bandwidth is contiguous 1400, BS 102 can send the starting RB,

$${RB}_{START}^{ACT} ,$$

and the number of RBs in the limited bandwidth,

$${N}_{RB}^{ACT} ,$$

using UE-specific RRC signaling. For example, as shown in FIG. 14, for a contiguous BW 1400,

$${RB}_{START}^{ACT} = 5$$

and

$${N}_{RB}^{ACT} = 14$$

are signaled by BS 102 to SS 116.

In some embodiments, when the limited bandwidth is distributed 1401, BS 102 can signal the positions of available RBs 610 or restricted RBs 615 using a high-layer signaling, such as, a UE-specific RRC signaling. For example, as shown in FIG. 14, Restricted RB-1 1411, RB-7 1412, RB-8 1413 and RB-9 1414 can be signaled to SS 116 using UE-specific signaling. Alternatively, RB-2 1421 to RB-6 1422 and RB-10 1423 to RB-22 1424 can be signaled to notify SS 116 the available RBs.

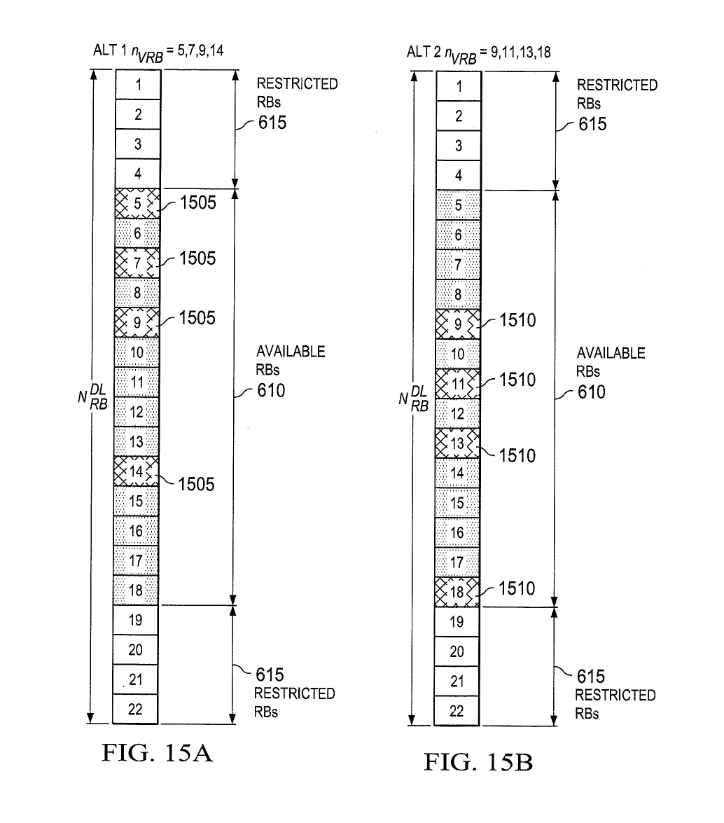

In some embodiments, when the VRB is a localized type, the virtual resource blocks are mapped to physical resource blocks such that the physical RBs are within the limited bandwidth. For example, the Virtual resource block n_{VRB} correspond to physical resource block n_{PRB}=n_{VRB} and in BS 102 scheduling, n_{VRB} includes only RBs in the limited bandwidth. In one example, as shown in FIG. 15A, n_{VRB}=5, 7, 9, 14 in indicating physicals RBs 5, 7, 9, 14 for this VRB 1505.

In an additional and alternative example, Virtual resource block n_{VRB} correspond to physical resource block n_{PRB}=Ñ_{PRB}(n_{VRB}), where Ñ_{PRB} is the set of available RBs and the downlink grant n_{VRB} indicates which RBs in Ñ_{PRB} are assigned in the VRB. In one example shown in FIG. 15B, n_{VRB}=5, 7, 9, 14 in indicating physicals RBs 9, 11, 13, 18 for this VRB 1510.

In some embodiments, when the VRB is the distributed type, the resource assignment, n_{VRB}, is defined on 0, 1, . . . ,

$${N}_{RB}^{DL} - 1$$

only, where

$${N}_{RB}^{DL}$$

is the number of available RBs. A mapping is defined from n_{VRB} to the physical RBs in this VRB. For example, assuming the set of available RBs is Ñ_{PRB}={2, 3, 5, 6, 7, 8, 15, 16, 17, 18, 19, 20}, then

$${N}_{RB}^{DL} = 12$$

and any element in n_{VRB} should be in the set (0, 1, . . . , 11).

In some embodiments, when the VRB is the distributed type, the resource assignment, n_{VRB}, is defined as in Rel-8. Here, a new mapping is defined to map the resource assignment n_{VRB} to n′_{VRB}, which is defined on 0, 1, . . . ,

$${N}_{RB}^{DL} - 1$$

where

$${N}_{RB}^{DL}$$

is the number of available RBs. A mapping can be defined from n′_{VRB} to the physical RBs in this VRB. In such embodiments, n_{VRB} can be larger than

$${\tilde{N}}_{RB}^{DL} .$$

In one example, assuming the set of available RBs is Ñ_{PRB}={2, 3, 5, 6, 7, 8, 15, 16, 17, 18, 19, 20} and

$${N}_{RB}^{DL} = 12 ,$$

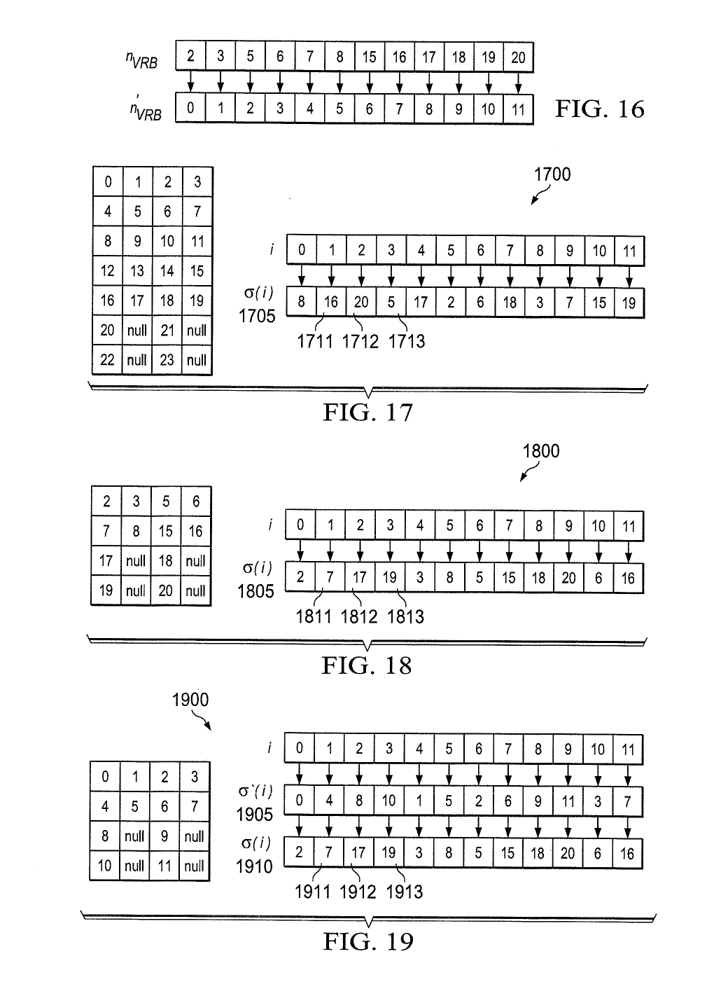

the mapping from n_{VRB} to n′_{VRB} can be defined as shown in FIG. 16. In this case, if n_{VRB}={17, 18, 19, 20}, n′_{VRB}={8, 9, 10. 11}. Two examples of the mapping from n′_{VRB} to the physical RBs in this VRB are illustrated in FIGS. 17 and 18.

In some embodiments, when the VRB is the distributed type, the following interleaving of the RBs for the mapping of VRB to only available physical RB (PRB) on the first slot in the sub-frame. The interleaver creates a mapping σ(i) from i, that is, the VRB index in the resource assignment, n′_{VRB}, defined on 0, 1, . . . ,

$${N}_{RB}^{DL} - 1 ,$$

to only the available RBs.

In one example shown in FIG. 17, in the block interleaver 1700 used, the indices of all physical RBs are written into a matrix in row wise from left to right and top to bottom. Some nulls are allowed to be inserted into the matrix following a certain predetermined rule. Then indices are read out column wise from top to bottom and left to right, neglecting nulls and restricted RES, to generate the mapping σ(i) 1705. Alternatively, the indices of all physical RBs are written into a matrix in column wise and then read out in row wise neglecting all nulls and restricted RBs to get the mapping σ(i) 1705. For example, the set of available RBs can be Ñ_{PRB}={2, 3, 5, 6, 7, 8, 15, 16, 17, 18, 19, 20} with twenty-four RBs in the PDSCH bandwidth. The indices of all RBs and some nulls are inserted into a matrix for the interleaver 1700. Then the indices are read out, ignoring nulls and restricted RBs, to generate the mapping σ(i) 1705. If n_{VRB}={1, 2, 3}, the PRB-16 1711, PRB-20 1712, and PRB-5 1713 would be used for the first slot of the sub-frame.

In some embodiments, the block interleaver 1800 is used. In the block interleaver 1800, the indices of only available physical RBs are written into a matrix in row wise from left to right and top to bottom. Some nulls are allowed to be inserted into the matrix according to a certain predetermined rule. Then the indices are read out column wise from top to bottom and left to right, neglecting nulls, to generate the mapping σ(i) 1805. Alternatively, the indices of only available physical RBs are written into a matrix in column wise and then we read out in row wise to get the mapping. For example, assume the set of available RBs is Ñ_{PRB}={2, 3, 5, 6, 7, 8, 15, 16, 17, 18, 19, 20}. The indices of available RBs, and some nulls, are inserted into a 4 by 4 matrix for the interleaver 1800 as shown in FIG. 18. Then the indices are read out, ignoring nulls, to generate the mapping σ(i) 1805. If n_{VRB}={1, 2, 3}, PRB-7 1811, PRB-17 1812, and PRB-19 1813 would be used for the first slot of the subframe.

In some embodiments, the block interleaver 1900 is used. In the block interleaver 1900, indices, 0, 1, . . . ,

$${N}_{RB}^{DL} - 1$$

are written into a matrix in row wise from left to right and top to bottom. Some nulls are allowed to be inserted into the matrix according to a certain predetermined rule. Then the indices are read out column wise from top to bottom and left to right, neglecting nulls, to generate the first-step mapping σ′(i) 1905. Alternatively, the indices of only available physical RBs are written into a matrix in column wise and then read out in row wise to get the mapping σ′(i) 1905. The mapping from σ′(i) 1905 to σ(i) 1910 can be σ(i)=Ñ_{PRB} (σ′(i)) in which σ′(i) 1905 is the indices of available RBs in Ñ_{PRB} or σ(i)=ƒ(σ′(i)), where ƒ( ) is a one-to-one mapping function from 0, 1, . . . ,

$${N}_{RB}^{DL} - 1$$

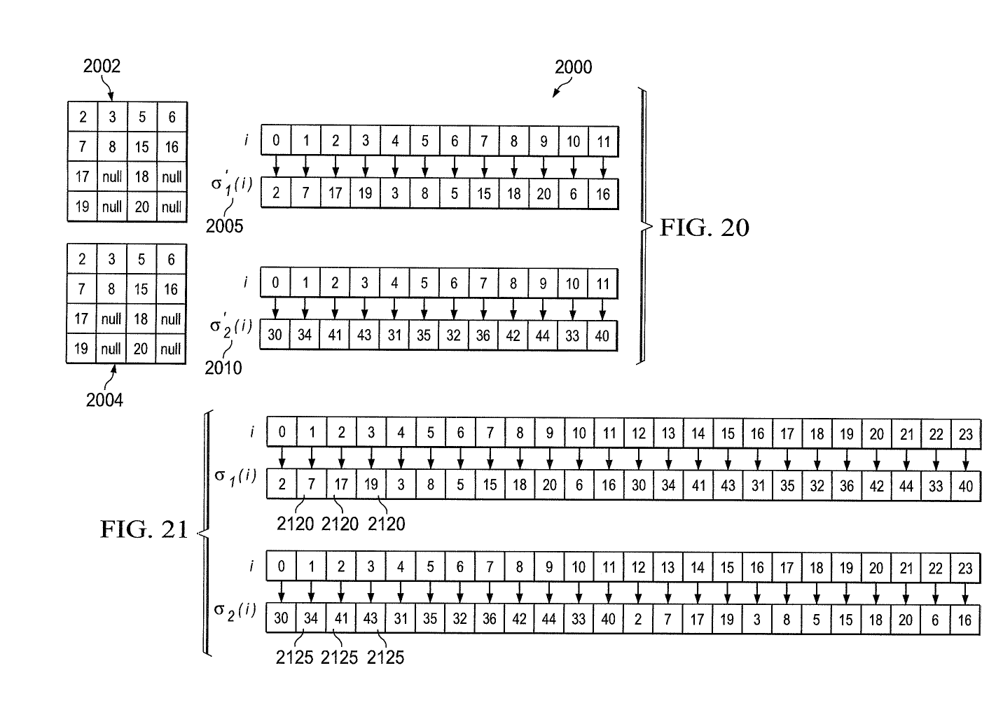

to Ñ_{PRB}. For example, assume the set of available RBs is Ñ_{PRB}={2, 3, 5, 6, 7, 8, 15, 16, 17, 18, 19, 20}. The indices 0 to 11, and some nulls, are inserted into a 4 by 4 matrix for interleaver 1900 as shown in FIG. 19. Then the indices are read out, ignoring nulls, to generate the mapping σ(i) 1905. If n_{VRB}={1, 2, 3}, σ′(i)=4, 8, 10, and PRBs-7 1911, PRB-17 1912, and PRE-19 1913 would be used for the first slot of the subframe if σ(i)=Ñ_{PRB} (σ′(i)).

In some embodiments, when the VRB is the distributed type, the RBs are interleaved for the mapping of VRB to only available physical RB (PRB) on the two slots in a subframe. The interleaver 2000 with matrices 2002, 2004 creates two mappings σ₁(i) 2005 and σ₂(i) 2010 from i 2015. The VRB index, n_{VRB} is defined on 0, 1, . . . ,

$${N}_{RB}^{DL} - 1 ,$$

to the available RBs that are used for the two slots.

In one example, the following block interleaver 2000 is used. In the block interleaver 2000, the indices of only available physical RBs are divided into two groups, Ñ_{pRB1} and Ñ_{PRB2}, with sizes

$${N}_{RB 1}^{DL}$$

and

$${N}_{RB 2}^{DL} ,$$

respectively. The indices of RBs in each group are written into a matrix in row wise from left to right and top to bottom. Some nulls are allowed to be inserted into the matrices according to a certain predetermined rule. Then the indices are read out column wise from top to bottom and left to right, neglecting nulls, to generate two mapping σ′₁(i) 2005 and σ′₂(i) 2010 from the two matrices 2002, 2004, respectively. Alternatively, the indices of only available physical RBs are written into a matrix in column wise and then the indices are read out in row wise to get the mapping. Here, σ′₁(i) 2005 and σ′₂(i) 2010 are given by Equation 21 and 22:

$${σ}_{1} ( i ) = \{ \begin{matrix}{σ}_{1}^{′} ( i ) & if i < {\tilde{N}}_{RB 1}^{DL} \\ {σ}_{2}^{′} ( i - {\tilde{N}}_{RB 1}^{DL} ) & otherwise\end{matrix} \qquad [ Eqn . 21 ]$$

and

$${σ}_{2} ( i ) = \{ \begin{matrix}{σ}_{2}^{′} ( i ) & if i < {\tilde{N}}_{RB 2}^{DL} \\ {σ}_{1}^{′} ( i - {\tilde{N}}_{RB 2}^{DL} ) & otherwise\end{matrix} \qquad [ Eqn . 22 ]$$

For example, the set of available RBs can be Ñ_{PRB}={2, 3, 5, 6, 7, 8, 15, 16, 17, 18, 19, 20, 30, 31, 32, 33, 34, 35, 36, 40, 41, 42, 43, 44}. This set is divided into two groups, such as: {2, 3, 5, 6, 7, 8, 15, 16, 17, 18, 19, 20}; and {30, 31, 32, 33, 34, 35, 36, 40, 41, 42, 43, 44}. The indices of available RBs, and some nulls, are inserted into two 4 by 4 matrices 2002, 2004, as shown in FIG. 20. Then the indices are read out, ignoring nulls, to generate the mapping σ′₁(i) 2005 and σ′₂(i) 2010. The mappings for the two slots are illustrated in FIG. 21. If n_{VRB}={1, 2, 3}, PRB-7, PRB-17, and PRB-19 2120 would be used for the first slot of the subframe and PRB-34, PRB-41, PRB-43 2125 for the second.

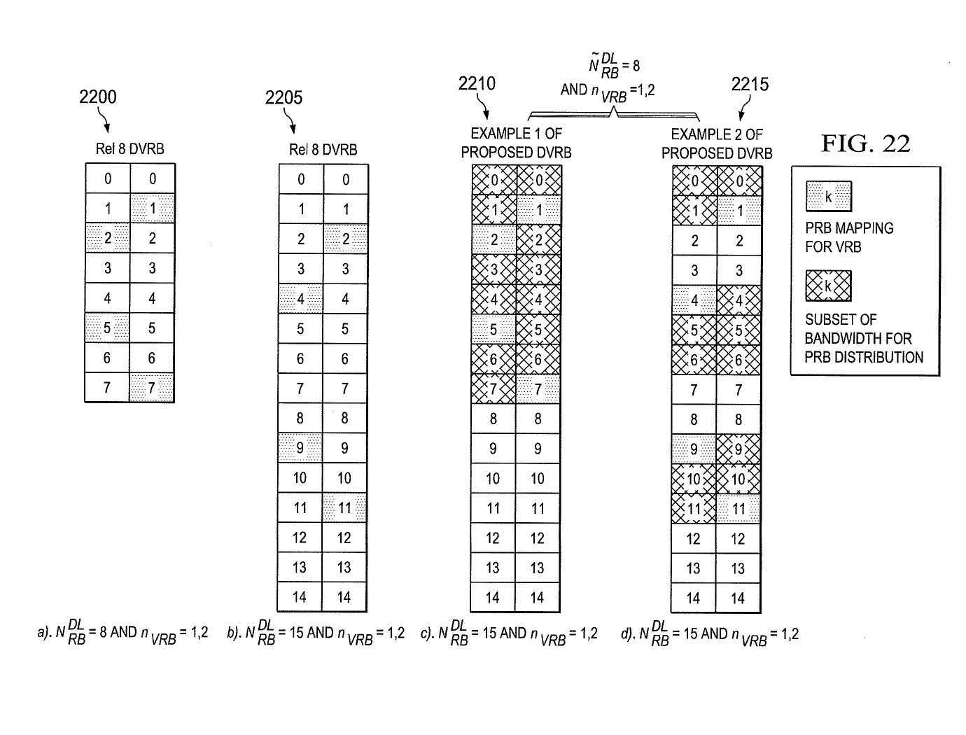

FIG. 22 illustrates a VRB mapping function according to embodiments of the present disclosure. The embodiment of the mapping function shown in FIG. 22 is for illustration only. Other embodiments could be used without departing from the scope of this disclosure.

In some embodiments, when the VRB is of the distributed type, a Rel-8 VRB mapping is applied on the available RBs rather than on the entire system bandwidth. Furthermore, if the number of available RSs is

$${\tilde{N}}_{RB}^{DL}$$

RBs, the Rel-8 VRB mapping with a

$${\tilde{N}}_{RB}^{DL}$$

RB system bandwidth is used to get the initial physical RBs and then map the initial physical RBs to the available RBs. The mapping from the initial physical RBs to the available RBs can be either a direct mapping, as shown in Equation 23 or a functional mapping as shown in Equation 24:

n_{PRB}(nₛ)=Ñ_{PRB}(\hat{n}_{PRB}(nₛ)) [Eqn. 23]

n_{PRB}(nₛ)=ƒ(\hat{n}_{PRB}(nₛ)) [Eqn. 24]

In Equations 23 and 24, \hat{n}_{PRB}(nₛ) is the initial index set of physical RBs given the resource allocation nₛ and n_{PRB}(nₛ) is the final RBs for the VRB in the available RBs.

In one example, virtual resource blocks of distributed type are mapped to open physical resource blocks according to a table function, such as illustrated by Table 1.

TABLE 1
Open RB gap values.

| | Gap (N_{gap}) | |
|---|---|---|
| Available BW ( ) | 1^{st} Gap (N_{gap,1}) | 2^{nd} Gap (N_{gap,2}) |
| 1-10 | $[ {\tilde{N}}_{RB}^{UL} \text{/} 2 ]$ | N/A |
| 11 | 4 | N/A |
| 12-19 | 8 | N/A |
| 20-26 | 12 | N/A |
| 27-44 | 18 | N/A |
| 45-49 | 27 | N/A |
| 50-63 | 27 | 9 |
| 64-79 | 32 | 16 |
| 80-110 | 48 | 16 |

The parameter N_{gap} is given by Table 1. For

$$1 \leq {\tilde{N}}_{RB}^{DL} \leq 49 ,$$

only one gap value N_{gap,1} is defined and N_{gap}=N_{gap,1}. For

$$50 \leq {\tilde{N}}_{RB}^{DL} \leq 110 ,$$

two gap values N_{gap,1} and N_{gap,2} are defined. The N_{gap}=N_{gap,1} or N_{gap}=N_{gap,2} is signaled as part of the downlink scheduling assignment. In contrast to Rel 8 where the system bandwidth

$${N}_{RB}^{DL} \geq 6 ,$$

the number of available RBs,

$${\tilde{N}}_{RB}^{DL} ,$$

can be smaller than six as the number of open physical resource blocks can be smaller than six.

Virtual resource blocks of distributed type are numbered from 0 to

$${N}_{VRB}^{DL} - 1$$

where:

$${N}_{VRB}^{DL} = {N}_{VRB , gap 1}^{DL} = 2 \cdot min ( {N}_{gap} , {\tilde{N}}_{RB}^{DL} ) for \\ {N}_{gap} = {N}_{gap , 1} ; and \\ {N}_{VRB}^{DL} = {N}_{VRB , gap 2}^{DL} = ⌊ \frac{{\tilde{N}}_{RB}^{DL}}{2 {N}_{gap}} ⌋ \cdot 2 {N}_{gap} for \\ {N}_{gap} = {N}_{gap , 2} \qquad [ Eqn . 25 ]$$

Consecutive

$${\tilde{N}}_{VRB}^{DL}$$

VRB numbers compose a unit of VRB number interleaving, where

$${\tilde{N}}_{VRB}^{DL} = {N}_{VRB}^{DL}$$

### for N_{gap}=N_{gap,1} and

$${\tilde{N}}_{VRB}^{DL} = 2 {N}_{gap}$$

for N_{gap}=N_{gap,2}. Interleaving of VRB numbers of each interleaving unit is performed with four columns and N_{row} rows, where

$${N}_{row} = ⌈ {\tilde{N}}_{VRB}^{DL} / ( 4 P ) ⌉ \cdot P ,$$

and P is RBG size. VRB numbers are written row by row in the rectangular matrix, and read out column by column. Nₙᵤₗₗ nulls are inserted in the last Nₙᵤₗₗ/2 rows of the 2^{nd} and 4^{th} column, where

$${N}_{null} = 4 {N}_{row} - {\tilde{N}}_{VRB}^{DL} .$$

Nulls are ignored when reading out. The VRB numbers mapping to PRB numbers including interleaving is derived as follows:

For even slot number nₛ;

$${\tilde{n}}_{PRB} ( {n}_{s} ) = \{ \begin{matrix}{\tilde{n}}_{PRB}^{′} - {N}_{row} , & \begin{matrix}{N}_{null} \neq 0 and {\tilde{n}}_{VRB} \geq {\tilde{N}}_{VRB}^{DL} - {N}_{null} \\ and {\tilde{n}}_{VRB} mod 2 = 1\end{matrix} \\ {\tilde{n}}_{PRB}^{′} - {N}_{row} + {N}_{null} / 2 , & \begin{matrix}{N}_{null} \neq 0 and {\tilde{n}}_{VRB} \geq {\tilde{N}}_{VRB}^{DL} - {N}_{null} \\ and {\tilde{n}}_{VRB} mod 2 = 0\end{matrix} \\ {\tilde{n}}_{PRB}^{″} - {N}_{null} / 2 , & \begin{matrix}{N}_{null} \neq 0 and {\tilde{n}}_{VRB} < {\tilde{N}}_{VRB}^{DL} - {N}_{null} \\ and {\tilde{n}}_{VRB} mod 4 \geq 2\end{matrix} \\ {\tilde{n}}_{PRB}^{″} , & otherwise\end{matrix}$$

Where:

$${\tilde{n}}_{PRB}^{′} = 2 {N}_{row} \cdot ( {\tilde{n}}_{VRB} mod 2 ) + ⌊ {\tilde{n}}_{VRB} / 2 ⌋ + {\tilde{N}}_{VRB}^{DL} \cdot ⌊ {n}_{VRB} / {\tilde{N}}_{VRB}^{DL} ⌋ ,$$

and

$${\tilde{n}}_{PRB}^{″} = {N}_{row} \cdot ( {\tilde{n}}_{VRB} mod 4 ) + ⌊ {\tilde{n}}_{VRB} / 4 ⌋ + {\tilde{N}}_{VRB}^{DL} \cdot ⌊ {n}_{VRB} / {\tilde{N}}_{VRB}^{DL} ⌋ , \qquad [ Eqn . 26 ]$$

where ñ_{VRB}=n_{VRB} mod Ñ_{VRB}^{DL} and n_{VRB} is obtained from the downlink scheduling assignment.

For odd slot number nₛ;

$${\tilde{n}}_{PRB} ( {n}_{s} ) = ( {\tilde{n}}_{PRB} ( {n}_{s} - 1 ) + {\tilde{N}}_{VRB}^{DL} / 2 ) mod {\tilde{N}}_{VRB}^{DL} + {\tilde{N}}_{VRB}^{DL} \cdot ⌊ {n}_{VRB} / {\tilde{N}}_{VRB}^{DL} ⌋ ;$$

Then, for all nₛ:

$${\hat{n}}_{PRB} ( {n}_{s} ) = \{ \begin{matrix}{\tilde{n}}_{PRB} ( {n}_{s} ) & {\tilde{n}}_{PRB} ( {n}_{s} ) < \frac{{\tilde{N}}_{VRB}^{DL}}{2} \\ {\tilde{n}}_{PRB} ( {n}_{s} ) + {N}_{gap} - \frac{{\tilde{N}}_{VRB}^{DL}}{2} , & {\tilde{n}}_{PRB} ( {n}_{s} ) \geq \frac{{\tilde{N}}_{VRB}^{DL}}{2}\end{matrix} \qquad [ Eqn . 27 ]$$

The physical resource blocks for all nₛ,

$${n}_{RB} ( {n}_{s} ) = {\tilde{N}}_{PRB} ( h ( {\hat{n}}_{PRB} ( {n}_{s} ) , {\tilde{N}}_{RB}^{DL} ) ) \qquad [ Eqn . 28 ]$$

where function h( ) is a bandwidth-dependent one-to-one mapping from

$$1 : {\tilde{N}}_{RB}^{DL} to 1 : {\tilde{N}}_{RB}^{DL} .$$

In one example, h(x)=x and

n_{RB}(nₛ)=Ñ_{PRB}(\hat{n}_{PRB}(nₛ)) [Eqn. 29]

FIG. 22 shows two examples of Rel-8 DVRB when the resource allocation is n_{VRB}=1, 2 and the system bandwidth is 8 2200 and 15 RBs respectively. Additionally, FIG. 22 illustrates two examples of the proposed DVRB when the limited bandwidth is either contiguous 2210 or non-contiguous 2215 and the number of available RBs is 8 and the system bandwidth is 15 RBs. Therefore, BS 102 is configured to DVRB map Rel-8 DVRB with 8-RB system bandwidth to the available RBs directly.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless communication network, a subscriber station comprising:
an antenna configured to receive data from and transmit data to at least one of a plurality of base stations; and
a controller configured to perform a frequency hop within a selected subset of a physical uplink shared channel (PUSCH), wherein the PUSCH comprises a plurality of available resource blocks and a plurality of restricted resource blocks and wherein the controller is configured to select a resource allocation within the plurality of available resource blocks.

2. The subscriber station as set forth in claim 1, wherein the plurality of available resource blocks comprise a non-contiguous set of resource blocks.

3. The subscriber station as set forth in claim 1, wherein the plurality of available resource blocks comprise a contiguous set of resource blocks.

4. The subscriber station as set forth in claim 1, wherein the controller is configured to determine the resource allocation based on a downlink message received from the at least one base station, the downlink message comprising one of: a semi-static signal, a higher layer signaling, a downlink grant, and a radio resource control message.

5. The subscriber station as set forth in claim 4, wherein the downlink message is configured to identify at least one of:
a start position of the resource allocation and a size of the resource allocation;
a start and end position of the plurality of available resource blocks; and
a start and end position of the restricted resource blocks.

6. The subscriber station as set forth in claim 1, wherein a total bandwidth of the PUSCH comprises a plurality of sub-bands, and wherein the controller is configured to identify at least one sub-band for the resource allocation.

7. The subscriber station as set forth in claim 6, wherein the plurality of sub-bands comprise:
a plurality of equal sub-bands, wherein the plurality of equal sub-bands are determined over a total number of the plurality of available resource blocks.

8. The subscriber station as set forth in claim 6, wherein the plurality of sub-bands comprise:
a plurality of resource blocks, wherein the plurality of equal sub-bands are determined over a total number of resource blocks for the PUSCH and wherein the controller is configured not to use at least one sub-band that includes a restricted resource block from the plurality of restricted resource blocks.

9. For use in a wireless communications network, a base station capable of communicating with a plurality of subscriber stations, the base station comprising:
a transmit path comprising circuitry configured to:
transmit control information and data to at least one of the plurality of subscriber stations in a subframe;
transmit a plurality of resource blocks in the subframe; and
map a plurality virtual resource blocks (VRB) to a plurality of available physical resource blocks (PRB) within a limited bandwidth of the sub-frame, wherein the sub-frame comprises the limited bandwidth and a plurality of restricted resource blocks.

10. The base station as set forth in claim 9, wherein transmit path is configured to map the plurality of VRB to the plurality of available PRB by re-mapping an existing mapping scheme to map the plurality of VRB to the plurality of available PRB within the limited bandwidth, the existing mapping scheme configured to map the plurality of VRB to a plurality of PRB for the entire bandwidth of the sub-frame.

11. The base station as set forth in claim 9, wherein the limited bandwidth comprises a non-contiguous set of available resource blocks.

12. The base station as set forth in claim 9, wherein the limited bandwidth comprises a contiguous set of available resource blocks.

13. The base station as set forth in claim 9, wherein the transmit path is configured to communicate, using a downlink message transmitted to the at least one subscriber station, at least one of: the limited bandwidth; the plurality of VRB; and a number of resource blocks within the VRB, wherein the downlink message comprising one of: a semi-static signal, a higher layer signaling, a downlink grant, and a radio resource control message.

14. The base station as set forth in claim 9, wherein transmit path is configured to map the plurality of VRB using a block interleaver configured to map the plurality of PRV to the plurality of available PRB.

15. The base station as set forth in claim 14, wherein the block interleaver is configured to receive indices of the available resource blocks in a first direction and read out the indices of the available resource blocks in a second direction.

16. The base station as set forth in claim 9, wherein transmit path is configured to map the plurality of VRB to the plurality of available PRB using at least two levels of mapping operations.

17. For use in a wireless communication network, a method for resource allocation, the method comprising:
transmitting control information and data to at least one of a plurality of subscriber stations in a sub-frame;
mapping a plurality virtual resource blocks (VRB) to a plurality of available physical resource blocks (PRB) within a limited bandwidth of the sub-frame, wherein the sub-frame comprises the limited bandwidth and a plurality of restricted resource blocks; and
transmitting the plurality of available PRB in the sub-frame.

18. The method as set forth in claim 17, wherein mapping comprises re-mapping an existing mapping scheme to map the plurality of VRB to the plurality of available PRB within the limited bandwidth, the existing mapping scheme configured to map the plurality of VRB to a plurality of PRB for the entire bandwidth of the sub-frame.

19. The method as set forth in claim 17, wherein the limited bandwidth comprises one of: a non-contiguous set of available resource blocks; and a contiguous set of available resource blocks.

20. The method as set forth in claim 17, wherein mapping comprises interleaving indices of available resource blocks by:
receiving the indices of the available resource blocks in a first direction; and
reading out the indices of the available resource blocks in a second direction.
